(19) United States
(12) Patent Application Publication
(10) Pub. No.: US 2011/0060998 A1
(43) Pub. Date: Mar. 10, 2011

(54) System and method for managing internet media content

(76) Inventors: Rick Schwartz, Carlsbad, CA (US); Osama Al-Shaykh, San Diego, CA (US); Ron Linyard, San Diego, CA (US); Mark Banham, San Diego, CA (US); Ralph Neff, Dan Diego, CA (US); Magdalena Leuca Espelien, San Diego, CA (US); Keith Hullfish, San Diego, CA (US)

(21) Appl. No.: 12/807,322

(22) Filed: Sep. 2, 2010

Related U.S. Application Data
(60) Provisional application No. 61/275,950, filed on Sep. 4, 2009.

(51) Int. Cl. G06F 3/01; G06F 15/16

(52) U.S. Cl. 715/738

(57) ABSTRACT

A system and a method manage internet media content by identifying relevant media content associated with a webpage, generating a symbolic representation for the identified media and/or presenting the symbolic representation of the identified media to enable media management, organization, retrieval, consumption and/or redirection functionality to be integrated with a web browsing experience. The system and the method may provide enhanced multimedia functionality integrated with a web browsing experience using an application providing web browser functionality, a plug-in program for an existing web browser, and/or an application associated and/or in communication with a web browser.

This application claims the benefit of U.S. Provisional Application Ser. No. 61/275,950, filed Sep. 4, 2009.

### BACKGROUND OF THE INVENTION

The present invention generally relates to a system and a method for managing internet media content. More specifically, the present invention relates to a system and a method that identify relevant media content associated with a webpage, generate a symbolic representation for the identified media, and/or present the symbolic representation of the identified media to enable media management, organization, retrieval, consumption and/or redirection functionality to be integrated with a web browsing experience.

The internet is a rich source of media content. Many websites present, share and/or distribute internet media content. Such internet media content may include image content, such as, for example, digital photographs, graphic images, bitmap images, vector graphics, animated image files and/or the like; audio content, such as, for example, digital audio files, music files, synthetic music files, encoded speech, audio podcast, audio streams, internet radio channels, ringtones, midi files and/or the like; and/or video content, such as, for example, video files, video clips, video podcasts, video streams, video channels, TV shows, movies, user-generated video and/or the like. Thus, a user with an internet connection and a suitable web browser application may access, browse, view and/or enjoy internet media content on a variety of websites.

Such websites may be, for example, digital photo sites such as Flickr (trademark of Yahoo! Inc.), video sites such as YouTube (trademark of Google Inc.), media search engines such as Google Images (trademark of Google Inc.), music sites such as Last.FM (trademark of Audioscrobbler Limited LLC) and Hype Machine (trademark of The Hype Machine Inc.), or any of a multitude of websites which may provide integrated and/or associated media content. Many websites have media content which may be accessed and/or may be consumed without cost to the user. Some media content types may require the user to obtain and/or install an associated media player application and/or a plug-in program, but typically the associated media player application and/or the plug-in program are also available at no cost to the user. Thus, media content sites provide the user with a convenient means to access internet media content and to use the internet media content within the webpages provided by the websites.

The use of internet media content within a webpage and/or a web browser has limitations. First, the user is typically limited to viewing, interacting with and consuming the internet media content associated with the webpage according to the organization, the presentation and the functionality enabled by the webpage. The ability to view, consume and/or play the associated media content is nearly always available. However, enhanced media functions, such as, for example, media searching, media organization, media management, bookmarking of media, marking favorite media, creating, editing and/or using playlists based on the media, and like functions, are rarely provided by the webpage. Additional enhanced media functions, such as, for example, the ability to direct the internet media content associated with the webpage to rendering devices in the home network and to synchronize the media content associated with the webpage to a portable media player, are not provided by in-page tools provided by the webpage.

Some websites with internet media content provide a subset of advanced features. For example, searching, bookmarking of favorites and/or downloading may be provided. However, when a website provides such functions within the webpage, the enabled functionality is limited to the internet media content provided by the website. Moreover, the available functionality and the user interface will vary for different websites. Thus, a user must learn to use the available functionality for each website of interest, and no common user interface for such functionality is available in the web browser and/or the associated webpage. Moreover, the site-specific in-page tools do not provide means to organize, manipulate, manage and/or consume the internet media content of multiple websites.

For example, digital photo sharing sites such as Flickr may provide tools to upload photos and to create and/or arrange albums which may be displayed as slide shows. However, the functionality is limited to photos the user uploaded to the Flickr website. The user interface to organize, edit, arrange and display an album in Flickr is not applicable to photos the user may find on or upload to other websites having internet media content, such as, for example, Snapfish (trademark of Hewlett-Packard Company) or Photobucket (trademark of Photobucket.com, Inc.), or to photos the user may find on other websites using a web-based search engine. The user must obtain and/or download such photos and subsequently upload them to Flickr to use the functionality provided by the Flickr in-page editing and organization facilities.

As another example, a music site such as Hype Machine may allow a user to browse and play music files on the website and to mark selected music files as “favorites” using tools provided by the webpages associated with the website. However, such tools are limited to internet media content provided by the specific website. Music files marked as “favorites” within a webpage of a music site such as Hype Machine will not be marked, will not be accessible and will not be found within the favorites function provided by a different website having internet media content. Different websites may present tools having similar functionality; however, the tools have different appearances, locations and behavior on each website. In addition, each set of tools is usable only with the internet media content provided by the specific website. As a further example, a music site may provide a tool to create and play a playlist, but playlists created with the tool are limited to the internet media content provided by the specific music site.

Such limitations on website functionality are often intentional because the media content site owner may provide such tools as an incentive for the user to continue use of the specific media content site. If the user makes the investment to create a user account on a website and learn to use the tools provided by the website, the user is likely to continue using the website and to continue viewing revenue-generating advertisements presented by the website. Typically, the website owner has no interest to enable functionality for competing websites having internet media content.

Media management applications are the most popular solution to this problem. Examples of media management applications are RealPlayer (trademark of RealNetworks, Inc.), SimpleCenter (trademark of Universal Electronics Inc.), iTunes (trademark of Apple Computer, Inc.) and Twonky Media Manager (trademark of PacketVideo Corporation). Media management applications enable the user to perform a multitude of media management, organization, consumption and/or redirection functions using media files in a media library. The media library may be associated with the media management application and/or may be located on one or more local media servers and/or local content storage locations which may be accessible to the media management application. A disadvantage of media management applications is that the media management application is a, separate experience from the web browser. A disadvantage of media management applications is that the media management application does not provide browser controls and is not capable of selecting, requesting, retrieving or rendering webpages. Thus, the user must find internet media content using a web browser but then must download the internet media content and add the internet media content to the media library, the local media server and/or the local content storage location before the internet media content may be used separately from the web browser in the media management application. Therefore, the additional functionality is not available directly in the web browsing experience in an integrated fashion.

FIG. 1 generally illustrates using a typical prior art system. The user utilizes a web browser to access various media content sites. The web browser presents standard browser controls which allow the user to select, navigate to and/or request a webpage associated with a media content website. As a result, the web browser may retrieve the webpage and the various elements on which the webpage may depend and may display a rendered webpage which the user may view, explore, and interact with in the web browser user interface. The webpage and/or the elements on which the webpage depends may have markup source, such as, for example, HTML, xHTML, XML and/or the like; text; graphics; active content objects, scripts and/or applications, such as, for example, Flash (trademark of Adobe System, Inc.), Flash Actionscript, JavaScript (trademark of Sun Microsystems, Inc.), ECMAscript, VBScript and/or the like; and/or media content.

The web browser may allow the user to find and/or render the media content in the rendered webpage and perform other functions which may be specifically enabled by the webpage and/or the scripts, the active content objects and/or the applications which may be embedded in the webpage. The web browser may allow the user to download the media content to a local media library, a local media server and/or another local storage location so that the user may use the media content outside of the web browser. Alternatively, the web browser and/or the means by which the media content website incorporates the media content into the webpage may not allow the user to download the media content using the web browser. In this case, the user may use other ways to download the media content associated with the webpage. For example, a “content downloading” website, such as “saveyoutube.com,” may allow the user to download the media content available from a media content website, such as YouTube, by entering the URL associated with the media content into a field on the “content downloading” website. Web browser plug-in programs are available which implement similar functionality.

After the internet media content is downloaded and saved to a local media library, the user may execute a separate media management application to access a local copy of the internet media content in the media library and/or to use any enhanced media functions provided by the media management application. However, the Internet media content downloaded to the local media library lacks the organization and the presentation of the media content website. Information, such as, for example, ratings, comments, relationships to other media, discussions about the media and the like are not available from the local copy of the internet media content. Moreover, the latest available media content on a dynamic media content website is not available in the media library.

Therefore, by downloading internet media content to a local media library, a local media server or other local content storage location, the user loses the dynamic vitality of the media content website associated with the Internet media content. In addition to providing access to media objects, a website typically has a unique organization and/or presentation. Further, a website typically has unique means of browsing, searching, updating and/or recommending the associated internet media content. For example, a webpage associated with a music website may provide music content relevant to a particular band, a particular music style and/or the favorite music of a music expert associated with the content site. To visit the website and download the content to local storage for use within a separate media management application is disadvantageous because the separate media management application does not preserve or provide the organization, presentation, and recommendation functions of the website and the associated webpages.

As a specific example, a media content website may provide information about a sports team. The media content website may allow users to post photographs taken at recent games played by the sports team, user-generated video content recorded at games played by the sports team, fan videos and/or the like. The media content posted on the media content website may be updated in real-time as the users post the media content and may be organized by the media content website in various ways. For example, the media content may be organized based on which user posted the media content, the game with which the media content is associated, an athlete featured in the media content, keywords entered by the user who posted the media content, the date the media content was posted and/or the like. The media content website may provide different webpages which implement the presentation and the organization of the media content and/or which organize the media content in different ways. For example, a first webpage of the media content website may present all of the media content posted by a particular user. A second webpage may present all of the user-generated video clips recorded by various users at a specific game. A third webpage may present all of the fan videos associated with a particular athlete.

The user may use a prior art web browser application to explore the media content website and to download individual media content objects of interest. The user may subsequently use a separate media management application to access the downloaded media content objects and utilize the enhanced media functions provided by the separate media management application. However, the user will not preserve the organization of the media content objects, the presentation of the media content objects and/or the additional information which may be displayed with the media content objects in the webpages provided by the media content website. Further, the separate media management application is not aware of and cannot present to the user the recently posted media content objects which may be available on the webpages associated with the media content website. The separate media management application is not aware of and cannot present to the user any media content which the user has not specifically discovered using the web browser and downloaded to a local media library, the local media server or the local content storage location.

The prior art merely partially addresses the above limitations. For example, RealPlayer provides a browser plug-in program which identifies video objects in the rendered webpage and provides means to download the video objects into the media library associated with RealPlayer. The technique is described in U.S. patent application Ser. No. 11/756,588 to Chasen et al. The plug-in program enables downloading of the video objects; however, the enhanced functionality is a separate experience in the separate RealPlayer application. The user must download the video content using the plug-in program. Then, the user must exit the browser to organize, manage and/or consume the downloaded video using the enhanced media functions of RealPlayer. The media management functionalities are not provided as an integrated browser experience, and media redirection functionality is not addressed.

Cooliris (trademark of Cooliris, Inc.) provides a browser plug-in program having enhanced visualization and navigation functions for images and videos on specific websites which support Cooliris. The Cooliris plug-in program renders photos and/or representative images from videos on an interactive “moving wall” to enhance the browsing and/or the exploration of the image and/or the video content associated with a webpage. The Cooliris plug-in program also supports marking the images and/or the videos which are recognized by the plugin as “favorites.” However, the Cooliris plug-in program is not capable of identifying relevant video and/or image content for generic websites.

Specific knowledge about the website must be provided to the Cooliris plug-in program to enable the visualization and favorites functionality for the website. Cooliris supports popular websites such as Flickr and YouTube. For other websites having internet media content, means are provided for the website owner to configure the website to be supported by Cooliris. For example, the owner of the website may flag the relevant content using the MediaRSS syndication standard or may use a site-enabling tool provided by Cooliris. However, most websites are currently not Cooliris-enabled. An end user of the Cooliris plug-in program cannot enable the functionality for a website which is not supported or for which the plug-in program does not function correctly. Further, the Cooliris plug-in program only provides the “favorites” function and does not provide the full range of media management and redirection functionality of a separate media management application.

Syndication standards such as Really Simple Syndication (RSS) or MediaRSS allow a media content website and/or a content provider to specifically flag content for publication. Applications with RSS Reader capabilities may use an RSS feed to determine the media content available from the RSS feed, the location for obtaining and/or downloading the media content and several metadata properties of the media content. Content updates are made available from the RSS feed, and updated media content may be downloaded automatically by a suitable RSS reader client. Accordingly, RSS is widely used to distribute audio and/or video podcast files. A significant limitation of RSS is that the media content website and/or the content provider must intentionally create and offer the RSS feed which describes the media content. However, most available internet media content is not offered from RSS feeds. Many media content websites are supported by advertising, and RSS feeds that enable users to automatically download updated media content without visiting the media content website and viewing the advertising is not in the financial interests of many media content website owners.

Moreover, the prior art does not provide a solution to the problem of separating relevant media, namely media suitable for downloading, managing, organizing, consuming, redirecting, synchronizing and/or otherwise using outside the context of the associated webpage, from irrelevant media, namely page graphics, background images, advertising content and/or content unsuitable for a current task and/or expressed preferences of the user. For example, the RealPlayer plug-in program identifies and offers to download advertising video content in the same way videos depicting the content of interest are identified and offered. The Cooliris plug-in program requires site-specific information to identify and present the target images and/or videos for a website having internet media content. Thus, for a website lacking site-specific support by Cooliris or for which the internet media content is not specifically flagged and/or identified by the content provider, the Cooliris plug-in program cannot correctly identify and present the target images and/or videos.

Redirection of internet media content to rendering devices in the home network (hereafter “redirection”) is of interest due to the emerging availability of low-cost media servers and rendering devices based on industry standard home networking technologies. The Universal Plug and Play (UPnP) Audio and Video (AV) standard defines a popular protocol by which media servers and rendering devices may be connected, may be controlled and may be used to process and play multimedia content. The Digital Living Network Alliance (DLNA) specifications provide additional details and conformance points to ensure UPnP AV-based home networking products correctly communicate with each other. Products based on the UPnP AV standard and/or the DLNA specifications allow the user to access, control and render media content files, such as, for example, audio files, video files, digital photographs and the like, in a multimedia-enabled home network.

Typically, the media content files reside on one or more media servers in the home network. The media content files may have been downloaded from the internet using the means discussed previously. Alternatively, the media content files may have been acquired without using the internet. For example, the user may have copied audio files from a CD or transferred video files from a camcorder and stored resulting audio and/or video files on one of the media servers in the home network. Based on a combination of internet and non-internet content sources, a user may build a local media collection on the one or more media servers in the home network. User input may then direct transmittal of the media content files from the one or more media servers to one or more of the rendering devices in the home network.

The home network may have various rendering devices, such as, for example, networked stereos, televisions, personal computers, digital photo frames and other devices which have media content rendering capabilities. The home network may also have control points which may be used to control the media servers and the rendering devices so that the user may discover and/or may select from the media content files and/or may control rendering of the media content files.

Thus, the existing home networking technologies may enable selection, delivery and/or rendering of the media content files which reside on the media servers in the home network. However, the media content files originating from the internet must be found by the user using a web browser, downloaded by the user and placed on one of the media servers to be accessible to the rendering devices in the home network. Therefore, the existing home networking technologies have a limitation similar to the limitation of the separate media management applications because the wide range of internet media content which may be discovered in a web browsing experience cannot be redirected to, sent to or rendered on rendering devices in a home network without the inconvenient steps of downloading the content, placing the content on a local media server, and exiting the web browser to use a separate application, such as a separate computer application, a stand-alone control point device or the user interface of the target rendering device.

### SUMMARY OF THE INVENTION

The present invention generally relates to a system and a method for managing internet media content. More specifically, the present invention relates to a system and a method that identify relevant media content associated with a webpage, generate a symbolic representation for the identified media and/or present the symbolic representation of the identified media in a compact, useful and manipulatable form to enable media management, organization, retrieval, consumption and/or redirection functionality to be integrated with a web browsing experience. The system and the method may provide enhanced multimedia functionality integrated with a web browsing experience using an application providing web browser functionality, a plug-in program for an existing web browser, and/or an application associated and/or in communication with a web browser.

To this end, in an embodiment of the present invention, a method for managing internet multimedia content in a network connected to the internet is provided. A terminal is connected to the network. The method has the steps of displaying a first webpage on the terminal wherein the first webpage has objects; identifying one or more of the objects as first media content objects wherein the first media content objects are automatically identified from the objects without user input identifying the first media content objects; generating a first set of symbolic representations wherein each symbolic representation of the first set of symbolic representations depicts one of the first media content objects; and concurrently displaying the first webpage and the first set of symbolic representations on the terminal wherein each of the symbolic representations of the first set of symbolic representations is displayed in a different location relative to the first media content object which the symbolic representation depicts.

In an embodiment, the method has the step of accepting user input on the terminal which identifies a type of content wherein the type of content is one of audio, video or images and further wherein the first set of symbolic representations depicts first media content objects which encode the type of content identified by the user input.

In an embodiment, the method has the step of using file type preferences to identify the first media content objects wherein the first media content objects have file types which correspond to the file type preferences.

In an embodiment, the method has the step of using properties of the objects to identify the first media content objects wherein the properties are at least one of width, height, aspect ratio, bitrate and quality level and further wherein the properties of the first media content objects meet a threshold value.

In an embodiment, the method has the step of analyzing protocol exchanges between the terminal and a remote server wherein the terminal analyzes the protocol exchanges to identify the first media content objects.

In an embodiment, the method has the step of obtaining a portion of one of the objects wherein the terminal uses the portion of the one of the objects to identify whether the one of the objects is one of the first media content objects.

In an embodiment, the method has the step of displaying a second webpage on the terminal after displaying the first webpage on the terminal wherein the second webpage and the first set of symbolic representations are displayed concurrently.

In an embodiment, the method has the step of displaying a second webpage on the terminal after displaying the first webpage on the terminal wherein second media content objects provided by the second webpage are automatically identified without user input identifying the second media content objects and further wherein a second set of symbolic representations is generated wherein each symbolic representation of the second set of symbolic representations depicts one of the second media content objects wherein the terminal concurrently displays the second webpage, the first set of symbolic representations and the second set of symbolic representations.

In an embodiment, the method has the step of processing a description of the first webpage wherein the terminal processes the description to identify the first media content objects.

In an embodiment, the method has the step of displaying a visual representation for each of a plurality of rendering devices connected to the network wherein the terminal concurrently displays the first webpage, the first set of symbolic representations and the visual representation for each of the plurality of rendering devices.

In an embodiment, each symbolic representation of the first set of symbolic representations is generated at least in part by analyzing at least one of a protocol exchange between the terminal and a remote server, a portion of one of the first media content objects, and a description of the first webpage.

In an embodiment, the method has the step of accepting first user input on the terminal which selects one or more of the first media content objects from the first webpage wherein the first set of symbolic representations includes symbolic representations which depict each of the one or more of the first media content objects selected by the first user input.

In an embodiment, the first user input selects the one or more of the first media content objects by visually moving the one or more of the first media content objects from the first webpage to a displayed area distinct from the first webpage.

In an embodiment, the method has the steps of displaying a second webpage on the terminal after displaying the first webpage on the terminal wherein the second webpage provides second media content objects; accepting second user input on the terminal wherein the second user input identifies one or more of the second media content objects; and concurrently displaying the second webpage, the first set of symbolic representations, and a second set of symbolic representations wherein each symbolic representation in the second set of symbolic representations depicts one of the second media content objects identified by the second user input.

In an embodiment, the method has the step of creating a playlist that has at least one of the first media content objects wherein the playlist is formed based on user input which selects one or more symbolic representations from the first set of symbolic representations.

In an embodiment, the method has the steps of accepting user input which identifies one or more of the first media content objects by selecting corresponding symbolic representations from the first set of symbolic representations; and rendering the one or more of the first media content objects identified by the user input on a rendering device accessible to the terminal over the network.

In an embodiment, the first set of symbolic representations is displayed in a workspace area which is visually distinct from the first webpage.

In an embodiment, the method has the steps of displaying a visual representation of a portable media player on the terminal; accepting user input on the terminal which identifies one or more of the first media content objects and identifies the portable media player; retrieving the first media content objects identified by the user input wherein the terminal retrieves the first media content objects identified by the user input from at least one remote server after accepting the user input; and transferring the first media content objects identified by the user input from the terminal to the portable media player.

In another embodiment of the present invention, a method for managing internet multimedia content in a network connected to the internet is provided. A terminal is connected to the network. The method has the steps of displaying a list of webpages on the terminal; accepting first user input on the terminal that identifies a first webpage from the list of webpages wherein media content objects are associated with the first webpage; displaying symbolic representations for one or more of the media content objects associated with the first webpage without displaying the first webpage wherein the symbolic representations are displayed in response to the first user input; and transmitting at least one of the media content objects associated with the first webpage to a media destination located outside of the terminal wherein the terminal transmits the at least one of the media content objects to the media destination without displaying the first webpage.

In an embodiment, the method has the steps of retrieving the first webpage from at least one remote server; identifying the media content objects associated with the first webpage; and generating the symbolic representations for the one or more of the media content objects associated with the first webpage wherein the terminal retrieves the first webpage, identifies the one or more of the media content objects, and generates the symbolic representations without displaying the first webpage.

In an embodiment, the method has the steps of accepting second user input on the terminal which selects one or more of the symbolic representations; and transmitting one or more of the media content objects associated with the first webpage to the media destination wherein the media content objects transmitted to the media destination correspond to the one or more of the symbolic representations selected by the second user input.

In an embodiment, the method has the steps of displaying a visual representation for the media destination wherein the media destination has media rendering capabilities; accepting second user input on the terminal which instructs the terminal to render the media content objects associated with the first webpage on the media destination wherein the second user input does not specify the media content objects to render; identifying a first set of media content wherein the first set of media content consists of the media content objects associated with the first website which are appropriate for rendering on the media destination and further wherein the terminal identifies the first set of media content based on the rendering capabilities of the media destination; and rendering the first set of media content on the media destination.

In an embodiment, the method has the steps of displaying a visual representation for each of a plurality of media destinations; accepting second user input on the terminal which identifies the first webpage, a second webpage from the list of webpages, and the media destination from the plurality of media destinations; identifying a first set of media content which consists of the media content objects associated with the first webpage wherein the terminal identifies the first set of media content; identifying a second set of media content which consists of media content objects associated with the second webpage wherein the terminal identifies the second set of media content; combining the first set of media content and the second set of media content into a common presentation wherein the common presentation is renderable using the media destination identified by the second user input; and rendering the common presentation using the media destination identified by the second user input.

In an embodiment, the method has the steps of accepting second user input on the terminal which identifies one or more of the symbolic representations; accepting third user input on the terminal which identifies one or more media files stored on a local media server; and creating a playlist based on the second user input and the third user input wherein the playlist includes at least one of the media content objects associated with the first webpage and at least one of the one or more media files stored on the local media server.

In an embodiment, the media destination is a rendering device which renders the at least one of the media content objects transmitted to the rendering device.

In an embodiment, the media destination is a local content server which stores the at least one of the media content objects transmitted to the local content server.

In an embodiment, the media destination is a portable media player which stores the at least one of the media content objects transmitted to the portable media player.

In another embodiment of the present invention, a system for managing internet multimedia content is provided. The system has a network connected to the internet; a plurality of rendering devices connected to the network wherein each of the rendering devices has rendering capabilities; and a terminal connected to the network wherein the terminal displays a first webpage which has objects and further wherein the terminal identifies media content objects from the objects without user input identifying the media content objects wherein the terminal uses the rendering capabilities to determine renderable media content objects from the media content objects and further wherein each of the renderable media content objects correspond to the rendering capabilities of at least one of the plurality of rendering devices wherein the terminal displays symbolic representations corresponding to the renderable media content objects.

In an embodiment, the terminal displays visual representations corresponding to the plurality of rendering devices wherein the terminal accepts user input which selects one of the visual representations and further wherein the terminal identifies to a user of the terminal which of the renderable media content objects are associated with the rendering capabilities of the one of the plurality of rendering devices which corresponds to the one of the visual representations selected by the user input.

In an embodiment, the terminal displays visual representations corresponding to the plurality of rendering devices wherein the terminal accepts user input which selects one of the symbolic representations and further wherein the terminal identifies to a user of the terminal which of the plurality of rendering devices is capable of rendering the one of the renderable media content objects which corresponds to the symbolic representation selected by the user input.

In an embodiment, the terminal acts as a UPnP AV Control Point.

In an embodiment, the system has a web browser on the terminal wherein the terminal uses the web browser to display the first webpage and further wherein the web browser supports a plug-in architecture; and a browser plug-in module on the terminal wherein the browser plug-in module communicates with the web browser using the plug-in architecture of the web browser and further wherein the terminal uses the browser plug-in module to identify the media content objects, to determine the renderable media content objects, and to display the symbolic representations corresponding to the renderable media content objects.

In an embodiment, a method for managing internet multimedia content in a network connected to the internet is provided. A terminal is connected to the network. The method has the steps of retrieving a first webpage wherein the terminal retrieves the first webpage from at least one remote server; displaying the first webpage in a first area of a display screen associated with the terminal; displaying symbolic representations in a second area of the display screen wherein the symbolic representations depict media content objects and further wherein one or more of the symbolic representations depict the media content objects associated with the first webpage wherein the first webpage and the symbolic representations are displayed concurrently; and rendering a first set of the media content objects wherein the user selects the first set of the media content objects by selecting one or more of the symbolic representations.

In an embodiment, the first area and the second area are separate areas of the display screen.

In an embodiment, the second area is displayed as overlapping and at least partially obscuring a portion of the first area.

In an embodiment, the method has the step of displaying a visual representation for at least one rendering device wherein the visual representation of the at least one rendering device is displayed concurrently with the symbolic representations.

In an embodiment, the method has the steps of displaying a visual representation for each of a plurality of rendering devices wherein at least one of the plurality of rendering devices is remote with respect to the terminal; and accepting user input on the terminal wherein the user input identifies a selected rendering device of the plurality of rendering devices and further wherein the first set of the media content objects is rendered on the selected rendering device.

In an embodiment, the method has the step of displaying page selection controls which indicate that multiple webpages are available in a current web browsing session wherein the page selection controls enable the user to select any of the multiple webpages for display and further wherein one or more of the symbolic representations depict additional media content objects associated with a second webpage which is one of the multiple webpages wherein the second webpage is a different webpage than the first webpage.

In an embodiment, one or more of the symbolic representations depict media files stored on a local content source available in the network and further wherein the first set of the media content objects includes at least one of the media content objects associated with the first webpage and at least one of the media files stored on the local content source.

In an embodiment, the method has the steps of obtaining rendering capabilities of a rendering device wherein the terminal obtains the rendering capabilities and further wherein the rendering device is accessible to the terminal over the network; and processing the first set of the media content objects wherein processing modifies at least one of the media content objects of the first set of the media content objects to match the rendering capabilities of the rendering device.

In an embodiment, the method has the steps of obtaining rendering capabilities of each of a plurality of rendering devices accessible to the terminal over the network wherein the terminal obtains the rendering capabilities; determining one or more rendering devices of the plurality of rendering devices which are capable of rendering the first set of the media content objects wherein the terminal uses the rendering capabilities to determine the one or more rendering devices which are capable of rendering the first set of the media content objects; and visually indicating to the user the one or more rendering devices which are capable of rendering the first set of media content objects.

In an embodiment, the method has the step of creating a playlist based on user input on the terminal which identifies one or more of the symbolic representations wherein the playlist includes at least one of the media content objects associated with the first webpage.

In an embodiment, the method has the step of visually identifying one or more of the media content objects in the first webpage in response to the user selecting one or more of the symbolic representations wherein the one or more of the media content objects which are visually identified correspond to the one or more of the symbolic representations selected by the user.

In an embodiment, the method has the step of visually identifying one or more of the symbolic representations in response to the user selecting one or more of the media content objects in the first webpage wherein the one or more of the symbolic representations which are visually identified correspond to the one or more of the media content objects selected by the user.

In an embodiment, the method has the step of determining a default media type for the first webpage wherein the default media type is one of audio content, video content and image content and further wherein each of the media content objects depicted by the symbolic representations has the default media type.

It is, therefore, an advantage of the present invention to provide a system and a method for managing internet media content.

Another advantage of the present invention is to provide a system and a method for managing internet media content that may identify the media associated with a webpage.

And, another advantage of the present invention is to provide a system and a method for managing internet media content that may identify only the media associated with a webpage which is relevant for redirection to and/or display on available rendering devices in a home network.

Yet another advantage of the present invention is to provide a system and a method for managing internet media content that may identify only the media associated with a webpage which is relevant for use outside the context of the webpage.

Still further, an advantage of the present invention is to provide a system and a method for managing internet media content that may identify only the media associated with a webpage which is relevant to specific tasks and/or user preferences specified by a user.

And, another advantage of the present invention is to provide a system and a method for managing internet media content that may identify media associated with a webpage and create a symbolic representation for the identified media.

Yet another advantage of the present invention is to provide a system and a method for managing internet media content that may identify media associated with a webpage, may create a symbolic representation for the identified media and may display the symbolic representation in a useful, compact form.

Still further, an advantage of the present invention is to provide a system and a method for managing internet media content that may display a compact list of the media concurrently with the webpage in a web browser.

And, another advantage of the present invention is to provide a system and a method for managing internet media content that may provide media management functions for media associated with a webpage and integrate the media management functions into a web browsing experience.

Still further, an advantage of the present invention is to provide a system and a method for managing internet media content that may provide media redirection functionality for media associated with a webpage and integrate the media redirection functionality into a web browsing experience.

Another advantage of the present invention is to provide a system and a method for managing internet media content that may identify media associated with multiple webpages selected by a user and enable management and/or redirection of the identified media combined from the multiple webpages.

Yet another advantage of the present invention is to provide a system and a method for managing internet media content that may enable media associated with a previously visited webpage to be selected and/or used as a unit without a need to display, browse and/or navigate the webpage.

Still further, an advantage of the present invention is to provide a system and a method for managing internet media content that may enable media associated with multiple previously visited webpages to be combined and consumed without a need to display, browse and/or navigate the multiple previously visited webpages.

Another advantage of the present invention is to provide a system and a method for managing internet media content that may identify only the media associated with a webpage that may be compatible with a portable media playback device.

Moreover, an advantage of the present invention is to provide a system and a method for managing internet media content that may process an existing list of bookmarked URLs to identify media associated with the bookmarked URLs so that the media may be managed, redirected and/or incorporated into playlists.

Additional features and advantages of the present invention are described in, and will be apparent from, the detailed description of the presently preferred embodiments and from the drawings.

### BRIEF DESCRIPTION OF THE DRAWINGS

FIG. 1 illustrates a prior art system for managing internet media content.

FIGS. 2 and 3 illustrate systems for managing internet media content in embodiments of the present invention.

FIGS. 4 and 5 illustrate flowcharts of methods for managing internet media content in embodiments of the present invention.

FIGS. 6-12 illustrate user interfaces for managing internet media content in embodiments of the present invention.

FIGS. 13-16 illustrate flowcharts of methods for managing internet media content in an embodiment of the present invention.

### DETAILED DESCRIPTION OF THE PREFERRED EMBODIMENTS

The present invention generally relates to a system and a method for managing internet media content. More specifically, the present invention relates to a system and a method that identify relevant media content associated with a webpage, generate a symbolic representation for the identified media content and/or present the symbolic representation of the identified media content in a compact, useful and manipulatable form to enable media management, organization, retrieval, consumption and/or redirection functionality to be integrated with a web browsing experience. The system and the method may provide enhanced multimedia functionality integrated with a web browsing experience using an application providing web browser functionality, a plug-in program for an existing web browser, and/or an application associated and/or in communication with a web browser. The system and the method may identify relevant media content associated with a webpage. A user may access, manage, organize, retrieve, consume and/or redirect the media content associated with a webpage or with multiple webpages without requiring the user to display, view, navigate or interact with the webpage or the multiple webpages.

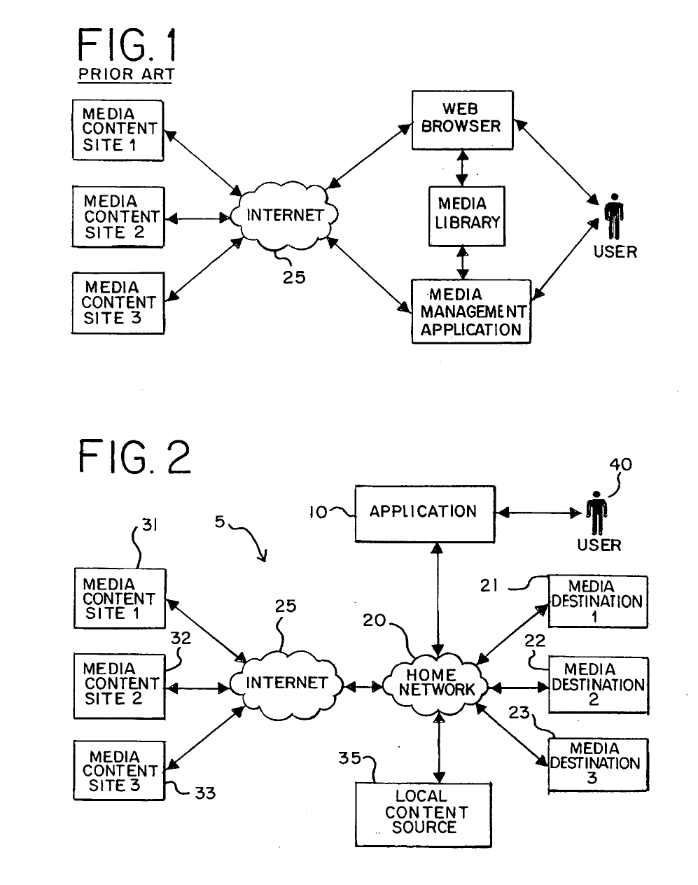

Referring now to the drawings wherein like numerals refer to like parts, FIG. 2 generally illustrates a system 5 for managing internet media content in an embodiment of the present invention. The system 5 may have an application 10 which may be connected to the internet 25 by a network 20. In a preferred embodiment, the network 20 may be a home network. The network may have connections that are wired or wireless. For example, the network 20 may be based on one or more of the following technologies: Ethernet/wired LAN, IEEE 1394 (“Fire Wire”) and/or IEEE 802.11 (“WiFi”). The network 20 may utilize other technologies not listed herein. The present invention is not limited to a specific embodiment of the network 20.

In an embodiment, the application 10 may be a self-contained software application for a personal computer, a laptop personal computer, a PDA, a mobile phone and/or another computing device which is capable of running software applications. In another embodiment, the application 10 may be a plug-in program to an existing web browser. As known to one having ordinary skill in the art, a plug-in program may be a secondary application that interacts with a host application to provide additional functions to the host application. In yet another embodiment, the application 10 may be a software application which may be associated and/or in communication with a separate browser application.

The application 10 may be provided by and/or stored by a computer readable medium, such as, for example, a compact disc, a DVD, a computer memory, a hard drive and/or the like. The computer readable medium may enable a computing device to execute the application 10. The computing device which executes the application 10 may be connected to the network 20. The computing device which executes the application 10 may be, for example, a personal computer, a laptop computer, a netbook computer, a mobile telephone, a personal digital assistant, a portable media player device, a mobile computing device, a gaming console, a portable gaming device, a networked remote control device, a dedicated standalone device, a network-capable television, a network-capable set-top box, a network-capable stereo system that may have a user interface screen, a network-capable audio adapter device that may have a user interface screen and/or the like. The network 20 may have more than one device that may execute the application 10. The present invention is not limited to a specific embodiment of the device which may execute the application 10 and/or on which the application 10 may reside.

The application 10 may use the network 20 and/or the internet 25 to access one or more media content sites. The media content sites may provide webpages which may store, which may be associated with, and/or which may provide access to media content. The media content may be and/or may have image content, audio content, video content and/or the like. For example, the media content sites may be one or more servers. The servers may be varying server types, such as, for example, web servers, media servers, proxy servers and/or the like. The media content sites may provide the media content to the application 10 using well-known internet delivery protocols, such as, for example, Hypertext Transfer Protocol (“HTTP”), Real Time Streaming Protocol (“RTSP”), Transmission Control Protocol (“TCP”), User Datagram Protocol (“UDP”) and/or Real-time Transport Protocol (“RTP”). The present invention is not limited to a specific embodiment of the media content sites, the webpages, the media content or means of delivery of the media content.

For example, the application 10 may access a first media content site 31, a second media content site 32 and/or a third media content site 33 (collectively “the media content sites 31,32,33”). The application 10 may access one or more local content sources, such as, for example, a personal computer; a laptop computer; a Network Attached Storage (“NAS”) device; a digital video recorder; a portable computing device such as a mobile telephone or a personal digital assistant; and/or a media capture device, such as a digital still camera or a camcorder. As shown in FIG. 2, the application 10 may access a local content source 35 via the network 20. Although not shown in the figure, local content sources not connected to the network 20 may be accessible to the application 10. For example, the application 10 may be a computer application running on a personal computer which has local content stored on a local hard drive, or which has access to local content stored on a device attached to the personal computer by a local connection, such as, for example, a USB cable. The present invention is not limited to a specific embodiment of the media content sites or the local content sources or a specific number of the media content sites or the local content sources. The system 5 does not have an upper limit to a number of media content sites or local content sources which may be accessed by the application 10. Any number of media content sites and local content sources may be used.

The application 10 may be connected to one or more media destinations. For example, a first media destination 21, a second media destination 22 and/or a third media destination 23 (collectively “the media destinations 21,22,23”) may be connected to the application 10 by the network 20. For example, in an embodiment, the first media destination 21 may be a DLNA-compatible television, the second media destination 22 may be a local media storage device with DLNA server capabilities, and/or the third media destination 23 may be a DLNA-compatible networked stereo adapter device capable of rendering digital music content to a stereo using an audio “line out” connection. Connection to one or more available media destinations may be established without using the network 20. For example, the application 10 may be a computer application running on a personal computer which is connected to a media destination, such as, for example, a portable media player, by a USB cable. In the case of multiple media destinations, the application 10 may be connected to one or more of the multiple media destinations using the network 20 and to one or more of the multiple media destinations using connections not using the network 20. The present invention may access any number of available media destinations, and the available media destinations may be accessed by the application 10 using any connection technologies known to one having ordinary skill in the art.

The media destinations 21,22,23 may be, for example, available rendering devices to which media content may be sent; portable media playback devices to which media content may be copied, synchronized and/or sent; media libraries, local media servers and/or media storage devices to which media content may be downloaded, copied and/or stored; media organization structures, such as, for example, folders, playlists and/or bookmark areas; and/or the like. The rendering devices may be, for example, a DLNA-compliant television, a DLNA-compliant set-top box connected to a television which may or may not be DLNA-compliant, a DLNA compliant stereo system, a DLNA-compliant audio adapter device connected to a stereo system which may or may not be DLNA compliant, a DLNA-compliant photo frame, a personal computer, a laptop computer, a mobile device, a mobile telephone, a personal digital assistant, a video game console, a UPnP AV rendering device and/or the like. The portable media playback devices may be, for example, a portable music player, a portable video player, a portable gaming device, a mobile telephone, a personal digital assistant, a portable photo viewer, and/or the like. The media destinations 21,22,23 may be any destination capable of receiving the internet media content as known to one skilled in the art.

A device may be both a media destination and a local content source. For example, a local media server may be a media destination to which the application 10 may download and/or may store the internet media content, and may be a local content source from which the application 10 may obtain local media content files and/or information about the local media content files.

As described in more detail hereafter, the application 10 may retrieve one or more webpages and/or elements on which the one or more webpages may depend. The one or more webpages may be identified and/or may be specified by a user 40. The application 10 may identify media content objects associated with the webpage which may be suitable for a current context, and/or may determine symbolic representations for the identified internet media content objects. The application 10 may present the symbolic representations in a workspace area of a user interface of the application 10.

As described in more detail hereafter, the application 10 may use the symbolic representations for the identified internet media content objects with controls, media destinations, symbolic representations of locally stored media content objects, and/or the like to enable enhanced media functions supported by the application 10. The enhanced media functions may be, for example, media management, organization, bookmarking, marking of favorites, playback, downloading, redirection to rendering devices in a home network, synchronization to portable media players, use of playlists, and/or like functions using the identified media content and/or the locally stored media content. An embodiment of the present invention may implement a subset of the enhanced media functions described herein. An embodiment of the present invention may implement additional enhanced media functions which are not described herein.

As a first example of functionality of the application 10, the application 10 may enable the user 40 to visually combine and/or arrange the symbolic representations of the identified media content objects and the locally stored media content objects as an ordered list of media content objects in a playlist. The application 10 may enable the user 40 to redirect the playlist to an available media destination, such as, for example, an available rendering device in the home network. As a result, the application 10 may send, may redirect and/or may initiate rendering of the ordered list of media content to the rendering device in the home network.

In doing so, the application 10 may act as a control point, such as, for example, a UPnP AV Control Point, to instruct the rendering device to subsequently request, retrieve and/or initiate rendering of each media content object in the ordered list of the playlist. Further, the application 10 may act as a media server, such as, for example, a UPnP AV MediaServer, to provide access to media content objects which are not available from the local content sources and/or which are not otherwise accessible to the rendering device. The application 10 may monitor a rendering status of each of the media content objects of the playlist as the playlist is rendered by the rendering device.

The application 10 may enable the user 40 to control rendering of each of the media content objects during rendering by the rendering device. The application 10 may initiate rendering of a new media content object from the playlist after completion of rendering of the previous media content object. Further, the application 10 may initiate rendering of a new media content object from the playlist after receiving user input requesting that the rendering skip forward to the next media content object, skip backward to a previous media content object, jump to a selected media content object in the playlist, and/or the like.

As a second example of functionality of the application 10, the application 10 may enable the user 40 to select a set of symbolic representations of the identified media content from one or more webpages. The application 10 may enable the user 40 to redirect the selected set of symbolic representations to a media destination which is a portable media playback device known to the application 10. As a result, the application 10 may retrieve the media content objects corresponding to the selected set of symbolic representations, and may copy, synchronize and/or send the corresponding media content objects to the portable media playback device. If the portable media playback device is not connected, is not reachable, and/or is not available, the application 10 may store the media content objects and/or references to the media content objects so that the media content objects may be copied to, may be synchronized to and/or may be sent to the portable media playback device at a future time. For example, the media content objects may be copied to, may be synchronized to and/or may be sent to the portable media playback device when the portable media playback device becomes connected, reachable and/or available.

As a third example, the application 10 may enable the user 40 to select a set of symbolic representations of identified video content objects from one or more webpages. The application 10 may enable the user 40 to redirect the selected set of symbolic representations to a “Favorite Videos” folder maintained by the application 10. As a result, the application 10 may store the video content objects corresponding to the selected set of symbolic representations and/or references to the video content objects corresponding to the selected set of symbolic representations so that the user 40 may access the corresponding video content objects using the “Favorite Videos” folder provided by the application 10.

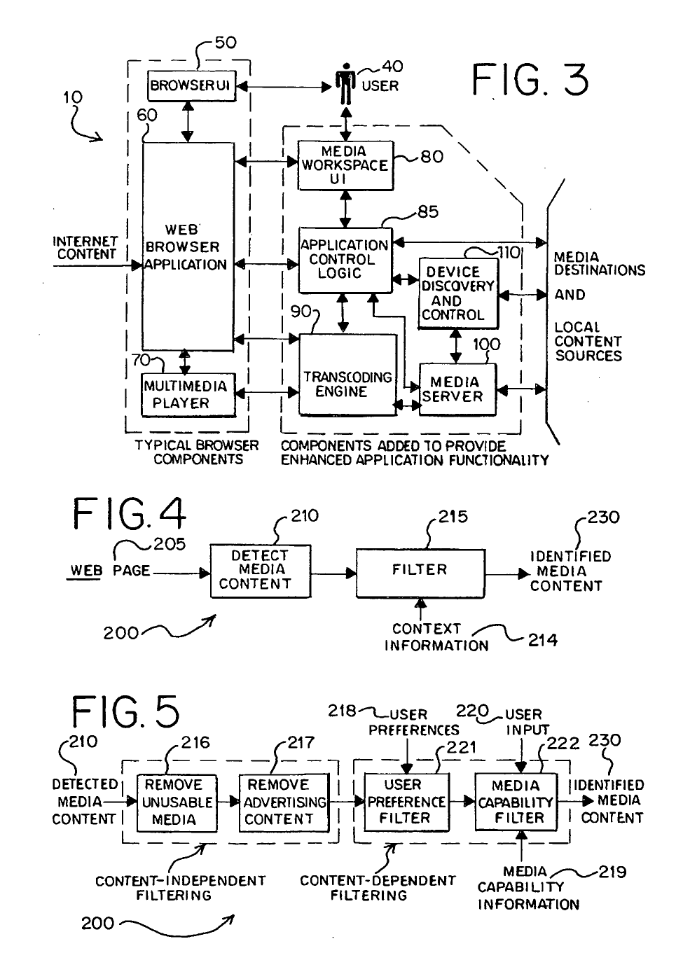

FIG. 3 generally illustrates a black box diagram of the application 10 in an embodiment of the present invention. The application 10 may have web browser components. For example, components of the application 10 may be a browser user interface 50, a web browser application 60 and/or one or more multimedia players 70.

The browser user interface 50 may present browser controls that may enable the user 40 to perform web browser tasks using the application 10. For example, the browser user interface 50 may enable the user 40 to search for internet content, to retrieve webpages and display the webpages as rendered webpages, to navigate within the rendered webpages, to select links in the rendered webpages, to retrieve and render internet media content accessible from the rendered webpages, and/or other web browser tasks and functionalities known to one having ordinary skill in the art. The browser user interface 50 may accept user input using input means associated with the device on which the application 10 resides. For example, the input means may be a keyboard, a keypad, a mouse, a 4-way navigation pad, a click wheel, a joystick, a touch screen, a set of programmable “soft keys,” a series of buttons on a remote control associated with a television or a set-top box and/or the like. The “soft keys” may be buttons which may perform a function dependent on text shown on a display screen adjacent to the buttons. The present invention is not limited to a specific embodiment of the input means.

The web browser application 60 may retrieve webpages from remote servers associated with media content sites such as, for example, the media content sites 31,32,33; may process and/or may interpret the webpages; may display the webpages as rendered webpages to the user 40 using the browser user interface 50; and/or may perform other web browser tasks known to one having ordinary skill in the art. The web browser application 60 may retrieve, may process, may decode and/or may render the internet media content associated with the webpages. The browser user interface 50 may render the internet media content retrieved, processed and/or decoded by the web browser application 60.

The multimedia player 70 that may be connected to and/or may be associated with the web browser application 60 may receive, may process, may decode and/or may render the internet media content. In an embodiment, the Internet media content and/or the locally stored media content may be received by the web browser application 60. The web browser application 60 may transmit the internet media content and/or the locally stored media content to the multimedia player 70 which may process and/or may decode the Internet media content and/or the locally stored media content. The multimedia player 70 may transmit decoded media content to the web browser application 60 which may render the decoded media content using the browser user interface 50.

The present invention is not limited to a specific arrangement of the web browser application 60 and the multimedia player 70. One having ordinary skill in the art will recognize alternative embodiments. For example, the media content may be received directly by the multimedia player 70 without passing through the web browser application 60. As another example, the multimedia player 70 may directly pass the decoded media content to the browser user interface 50, to a display of the device on which the application 10 resides, and/or to an additional device associated with the device on which the application 10 resides. The present invention is not limited to the arrangement of the components of the application 10 illustrated in FIG. 3.

As FIG. 3 generally illustrates, an embodiment of the application 10 may have additional components which may provide enhanced media functions of the application 10. The application 10 may have a media workspace user interface 80 which may enable the user 40 to access the symbolic representations of the identified media content and/or to control the enhanced media functions of the application 10. The application 10 may have a transcoding engine 90 which may transcode, may reformat and/or may repurpose the media content for compatibility with one or more of the media destinations 21,22,23 in the network 20. The application 10 may have a media server component 100 which may transfer the media content to one or more of the media destinations 21,22,23 in the network 20.

The application 10 may have a device discovery and control component 110 (hereafter “the DDC component 110”) which may determine the availability of media destinations in the network 20 and/or the availability of media destinations which may be connected to and/or accessible to the application 10 without using the network 20. The DDC component 110 may determine media capabilities of the available media destinations. The DDC component 110 may communicate with the media destinations to determine the presence or absence of the media destinations; to determine the media capabilities of the media destinations; and/or to initiate, maintain and/or control delivery of the media content to, rendering of the media content by, and/or storage of the media content on the available media destinations.

As an example, the DDC component 110 may determine the available rendering devices in the network 20. The DDC component 110 may determine the capabilities of the available rendering devices in the network 20. The available rendering devices in the network 20 may transmit messages in the network 20 to communicate availability and/or the capabilities to other devices in the network 20. The DDC component 110 may receive the messages from the available rendering devices. The DDC component 110 may use the network 20 to communicate with the available rendering devices to determine a current status of the available rendering devices and/or to determine additional capabilities for the available rendering devices. The DDC component 110 may consult additional sources, such as, for example, a capabilities database to determine the capabilities and/or the additional capabilities of the available rendering devices. The capabilities and/or the additional capabilities may indicate the media capabilities for the available rendering devices.

The DDC component 110 may create, may maintain and/or may update an internal list of the available rendering devices in the network 20. The internal list may have the media capabilities of the available rendering devices. The media capabilities of the available rendering devices may have and/or may be, for example, media types, such as, for example, audio, video and/or image; multimedia codecs, such as, for example, AAC Audio codec, H.264 video codec and/or the like; profiles and/or levels associated with the multimedia codecs; transport methods; and/or digital rights management (“DRM”) technologies which may be supported by the available rendering devices. The present invention is not limited to a specific embodiment of the media capabilities which may be determined by the DDC component 110.

In response to user input directing a target rendering device to render one or more media content objects, the DDC component 110 may communicate with the target rendering device. The DDC component 110 may instruct the target rendering device to request, to retrieve, to process and/or to render one or more media content objects. The DDC component 110 may specify an appropriate location from which each of the media content objects may be retrieved by the target rendering device. The location may specify a local content source in the network 20, a remote server associated with a media content site, the media server component 100 of the application 10, and/or the like. The location may be a URL, such as, for example, an HTTP URL, an RTSP URL, and/or the like.

The DDC component 110 may communicate with the target rendering device to control the rendering of the one or more media content objects. For example, the DDC component 110 may control the rendering of the one or more media content objects by the target rendering device in accordance with playback controls which may be presented by the application 10 in the media workspace user interface 80 and/or which may be accessed, invoked and/or used by the user 40. The DDC component 110 may transmit rendering control instructions to the target rendering device. The rendering control instructions may correspond to the playback controls, such as, for example, “Play,” “Pause,” “Stop,” “Rewind,” “Fast Forward,” “Seek to a specific time,” “Volume Up,” “Volume Down,” “Skip to the next media content object,” “Skip to the previous media content object”, “Jump to a specified media content object,” and/or other playback controls known to one having ordinary skill in the art. In an embodiment, the DDC component 110 may be and/or may act as a UPnP AV Control Point and/or a DLNA Control Point.

As a second example, the DDC component 110 may determine the available portable media playback devices which may be accessible to the application 10. The DDC component 110 may determine the capabilities of the portable media playback devices. The DDC component 110 may exchange protocol messages with the portable media playback devices to determine the capabilities of the portable media playback devices and/or other properties of the portable media playback devices. The other properties may be, for example, a manufacturer name, a model number, a description, a graphic representation, and/or like properties of the portable media playback devices. The DDC component 110 may communicate with the portable media playback devices and/or may consult additional sources such as, for example, a capabilities database to determine the capabilities and/or additional capabilities of the portable media playback devices. The capabilities and/or the additional capabilities may indicate the media capabilities for the portable media playback devices.

The DDC component 110 may create, may maintain and/or may update an internal list of the portable media playback devices. The internal list may have the media capabilities and/or the other properties of the portable media playback devices. The internal list may include portable media playback devices which are not currently connected to and/or available to the application 10. For example, the internal list may include portable media playback devices which have previously been connected to the application 10, which have been configured by the user 40, and/or which are otherwise known to the application 10.

In response to user input directing transfer of one or more media content objects to one of the portable media playback devices, the DDC component 110 may communicate with the transcoding engine 90 and/or the media server component 100 to obtain the one or more media content objects in a form which may match the media capabilities of the portable media playback device. As a result, the one or more media content objects may be requested, may be retrieved, may be transcoded, may be reformatted, and/or may be repurposed for transfer to the portable media playback device. The DDC component 110 may communicate with the portable media playback device to transfer the one or more media content objects to the portable media playback device.

In an embodiment, the DDC component may determine that the portable media playback device is not connected to and/or not available to the application 10. As a result, the DDC component 110 may delay transfer of the media content objects until a future time when the portable media playback device may be connected and/or may be available. In an embodiment, the DDC component 110 may transfer a set of media content objects having a combination of internet media content and locally stored media content to the portable media playback device. In an embodiment, the DDC component 110 may transfer a set of media content objects to the portable media playback device with a playlist which may reference one or more of the media content objects of the set. The playlist may be recognizable to and/or compatible with the portable media playback device. In an embodiment, the DDC component 110 may be and/or may act as a Media Transfer Protocol (MTP) Initiator.

The application 10 may have the transcoding engine 90 which may transcode, may reformat and/or may repurpose the media content for compatibility with one or more of the available media destinations. The transcoding engine 90 may receive instructions resulting from user input in the media workspace user interface 80 indicating that a set of selected internet media content and/or selected locally stored media content should be redirected to a specified media destination. The transcoding engine 90 may communicate with the DDC component 110 to determine the capabilities of the specified media destination. The transcoding engine 90 may access the internet media content using the web browser application 60 and/or the multimedia player 70. The transcoding engine 90 may have alternative connections by which the internet media content may be accessed and/or may be obtained. For example, the transcoding engine 90 may be capable of accessing the internet media content directly using the internet 25 and/or the network 20. The transcoding engine 90 may access the locally stored media content using the network 20 and/or by other means not using the network 20. The other means may be, for example, a USB cable connected to a device having the locally stored media content. The transcoding engine 90 may process the internet media content and/or the locally stored media content to prepare the media content for delivery to the specified media destination. The transcoding engine 90 may transcode the internet media content and/or the locally stored media content based on the media capabilities of the specified media destination. For example, the transcoding engine 90 may transcode the media content to produce transcoded media content which may conform to media codecs, profiles and/or levels which may be supported by the specified media destination. The transcoding engine 90 may reformat the media content. For example, the transcoding engine 90 may reformat the media content to produce reformatted media content which may have a file format and/or a delivery format appropriate for the specified media destination.

The transcoding engine 90 may examine digital rights management protection (hereafter “the DRM protection”), if any, of the media content to determine restrictions for transferring the media content to and/or rendering the media content on the specified media destination. The transcoding engine 90 may determine that the restrictions require secure transfer of the media content to the specified media destination. The transcoding engine 90 may reformat the media content for secure transfer to the specified media destination, and/or the transcoding engine 90 may inform the media server component 100 that the secure transfer may be required. The reformatting for and/or the communication about the secure transfer may reflect a specific method of secure transfer which may be required by the restrictions. The transcoding engine 90 may determine that the restrictions for the media content do not permit transferring the media content to and/or rendering the media content on the specified media destination. The transcoding engine 90 may not permit transfer of the media content to and/or rendering of the media content on the target rendering device. The application 10 may inform the user 40 that transfer of the media content to and/or rendering of the media content on the target rendering device may not be allowed due to the restrictions.

In an embodiment, the transcoding engine 90 may not be available in and/or may not be provided by the application 10. In this case, the transcoding engine 90 may be replaced with a “pass-through” connection that may enable the internet media content to pass directly from the web browser application 60, the multimedia player 70, and/or the internet 25 to the media server component 100 and/or the media destinations 21,22,23.

The application 10 may have the media server component 100 which may receive and/or may access the media content to make the media content available to one or more of the media destinations. The media content may be transcoded, reformatted and/or repurposed internet media content received from the transcoding engine 90. The media content may be internet media content which may have been retrieved from a server associated with a media content site and/or may not have been transcoded, reformatted and/or repurposed. The media content may be locally stored media content accessible to the application 10.

For example, the media server component 100 may be and/or may act as a web server, an RTSP media server, a UPnP AV media server, a DLNA compliant media server, an HTTP Proxy Server and/or any media server known to one having ordinary skill in the art. The present invention is not limited to a specific embodiment of the media server component 100.

The media server component 100 may deliver the media content to the specified media destination, such as, for example, the target rendering device, using the network 20. The media server component 100 may store and/or may buffer a portion and/or an entirety of the media content. The media server component 100 may be visible to and/or may be accessible to rendering devices, portable media players, other media destinations, control points and/or multimedia clients which may be accessible to the application 10 using the network 20 and/or other means.

The media server component 100 may identify, may indicate availability of and/or may provide access to the media content identified by the application 10, such as, for example, internet media content which has been bookmarked, marked as favorite content, selected, added to a playlist, or otherwise accessed in the media workspace user interface by the user 40; the internet media content associated with webpages browsed, visited, selected and/or specified by the user 40; locally stored media content files; and/or the media content associated with and/or referenced by playlists created by the user 40. The media server component 100 may indicate the availability of the media content based on bookmarks, favorites, organizational structures, playlists and/or folders which the user 40 may have created using the enhanced media functions of the application 10. The media server component 100 may indicate the availability of the media content and/or may provide access to the media content to the rendering devices, portable media players, other media destinations, control points and/or multimedia clients which may be accessible to the application 10 using the network 20 and/or other means. For example, the media server component 100 may indicate the availability of the media content and/or may provide the access to the media content regardless of whether the application 10 is being actively used and/or controlled by the user 40 using the browser user interface 50 and/or the media workspace user interface 80. Thus, the user 40 may discover, may select and/or may access the media content, such as, for example, the internet media content, directly from the media destinations, the control points and/or other applications in the network 20.

The application 10 may have a control logic component 85 which may identify media content associated with and/or accessible from one or more webpages identified by and/or specified by user 40; may determine the symbolic representations for the identified media content; and may display one or more of the symbolic representations for the identified media content in a workspace area, such as, for example, the media workspace user interface 80 of the application 10. Additional details will be provided below regarding these functions which may be provided by the control logic component 85 of the application 10.

The control logic component 85 may request, may receive and/or may process the description of one or more webpages and/or elements on which the one or more webpages may depend. The control logic component 85 may obtain the description and/or the elements from the web browser application 60, the multimedia player 70, and/or one or more servers available using the internet 25 and/or the network 20. The control logic component 85 may be connected to and/or may communicate with available media libraries, local media servers, and/or other local content sources to obtain information about locally stored content which may be available to and/or may be accessible to the application 10.

The control logic component 85 may communicate with the media workspace user interface 80, the DDC component 110, the media server component 100, the transcoding engine 90 and/or other components of the application 10 to control and/or to coordinate the various components to provide the enhanced media functions in an embodiment of the present invention.

The control logic component 85 may create, maintain, and/or store records to provide the enhanced media functions. As a first example, the records may have media content which has been bookmarked, marked as favorites, and/or organized within the application 10. As a second example, the records may have user preferences which may indicate preferred media destinations, criteria for including and/or excluding media from a set of identified media content, and/or the like. As a third example, the records may have playlists which may have been created and/or may have been saved by a user. The present invention is not limited to a number or a type of records which may be created, may be maintained and/or may be stored by the control logic component 85.

For example, the user 40 may discover Internet media content using the browser user interface 50 of the application 10. Then, the user 40 may bookmark the internet media content using the media workspace user interface 80 and/or the enhanced media functions of the application 10. The media server component 100 of the application 10 may act as a UPnP AV media server to indicate availability of the bookmarked internet media content to UPnP compliant control points and/or rendering devices in the network 20.

At a later time, the user 40 may watch video content on a UPnP AV compliant television in the network 20. The user 40 may access the media server component 100 of the application 10 using a user interface provided by the UPnP AV compliant television. The availability of the bookmarked internet media content may be indicated to the user 40 by the media server component 100, and/or the user 40 may select a specific bookmark to view the associated media content on the UPnP AV compliant television. In response to selection of the specific bookmark, the UPnP AV compliant television may request the associated media content from the media server component 100 of the application 10. The application 10 may request the associated media content from a media content site that provides the media content associated with the specific bookmark. The application 10 may receive the media content associated with the specific bookmark from the media content site. The transcoding engine 90 may transcode, may reformat and/or may repurpose the media content for compatibility with the UPnP AV compliant television. The application 10 may begin transmitting the transcoded, reformatted and/or repurposed media content to the UPnP AV compliant television for rendering as the transcoding engine 90 transcodes, reformats and/or repurposes the media content.

The media server component 100 may receive request messages from the target rendering device which may request the transcoded, reformatted and/or repurposed internet media content. The request messages from the target rendering device may request specific portions of the transcoded, reformatted and/or repurposed internet media content. The media server component 100 may receive instructions from the transcoding engine 90 and/or from other components of the application 10. The instructions may direct the media server component 100 to transmit the transcoded, reformatted and/or repurposed internet media content. The instructions may direct the media server component 100 to transmit the specific portions of the transcoded, reformatted and/or repurposed internet media content. In response to the request messages and/or the instructions, the media server component 100 may transmit the transcoded, reformatted and/or repurposed internet media content and/or the specific portions to the target rendering device.

As discussed previously, in an embodiment, the application 10 may be a self-contained software application for a personal computer, a laptop personal computer, a PDA, a mobile phone and/or another computing device which is capable of running software applications. In another embodiment, the application 10 may be a plug-in program for an existing web browser. In an embodiment where the application 10 is a plug-in program, the application 10 may have the media workspace user interface 80, the control logic component 85, the transcoding engine 90, the media server component 100 and/or the DDC component 110. The application 10 may connect to an existing web browser which may support a standard plug-in architecture as known to one having ordinary skill in the art. For example, the application 10 may connect as a plug-in program to a web browser of Internet Explorer (trademark of Microsoft Corp.), Firefox (trademark of Mozilla Foundation), Opera (trademark of Opera Software ASA Norway), Google Chrome (trademark of Google Inc.) and/or the like. In another embodiment, the application 10 may be a software application which may be associated and/or may be in communication with a separate web browser application.

In yet another embodiment, the application 10 may be a stand-alone application which may have access to a list of webpages which may have, may be associated with, and/or may provide internet media content. The application 10 may have one or more of the previously discussed components, and the application 10 may not have one or more of the previously described components. For example, the application 10 may not have the browser user interface 50 and, therefore, may not enable the user 40 to view, explore and/or interact with rendered webpages. The application 10 is not limited to the specific embodiment depicted in FIG. 3.

FIG. 4 generally illustrates a flowchart of a method 200 for managing internet media content in an embodiment of the present invention. The method may be executed by the application 10. The method 200 may identify media content associated with a webpage. In a preferred embodiment, the method 200 may be applied to any webpage which may be requested, may be retrieved and/or may be accessed using an available network connection. The method 200 may not require special knowledge about the webpage or about the media content associated with the webpage. The method 200 may identify relevant media content from the media content associated with the webpage. For example, the method 200 may identify the media content of the webpage which may be potentially relevant for a current task, an environment and/or a context. Then, the method 200 may apply an intelligent filtering process which may remove content irrelevant for the current task, the environment and/or the context.

As generally illustrated at step 205, a description of the webpage may be provided. The description of the webpage may have a page source which may include a markup source, links, scripts and/or active objects. The markup source may include, for example, HTML, xHTML, XML and/or the like. The links may be, for example, URLs which may reference additional markup source, scripts, active objects and/or media content. The scripts and/or the active objects may include, for example, JavaScript, ECMAScript, VBScript, Flash ActionScript, and/or code written in other scripting languages which may be executed during interaction with and/or rendering of the webpage. Alternatively, the description of the webpage may be an internal representation of a previously retrieved and/or parsed webpage. For example, the description of the webpage may be a Document Object Model (“DOM”) representation of a webpage accessed using a standard API provided by a web browser as known to one having ordinary skill in the art. The DOM representation may enable the application 10, a browser plug-in program, an application associated with the web browser, and/or an active script of the webpage to access the structure, the content, the links, the scripts and/or the active objects of the webpage. The present invention is not limited to a specific embodiment of the description of the webpage, and the present invention may utilize any description of the webpage known to one having ordinary skill in the art.

The description of the webpage may be processed as follows. As generally shown at step 210, the media content associated with the webpage may be detected. The detected media content may be, for example, image content, audio content and/or video content relevant to and/or compatible with a set of available media management and/or redirection tasks. As generally illustrated at step 215, filtering of the media content may remove the media content which may not be relevant for a current context. The filtering of the media content may generate a set of identified media content as generally shown at step 230.

In an embodiment, the identified media content may be identified by records having a link and/or a URL that directs to the identified media content. The records may have additional identifying information and/or metadata that may describe the identified media content. The additional identifying information and/or the metadata may have been discovered during detection of the media content associated with the webpage and/or the filtering of the media content. The detection of the media content associated with the webpage and/or the filtering of the media content may result from processing the description of the webpage.

At step 210, the detection of the media content associated with the webpage may utilize a set of known media types, file types, file extensions and/or MIME types relevant to the set of available media management and/or redirection tasks. Relevant image types may be, for example, bitmap files, JPEG files, TIFF files, PNG files, SVG files and/or the like. Relevant audio types may be, for example, MP3 files, AAC audio files, Windows Media Audio files, FLAC files, Ogg audio files and/or the like. Relevant video types may be, for example, Flash Video files, MP4 files, 3GPP media files, 3GPP2 media files, Windows Media Video files, AVI files, ASF files, QuickTime files, Ogg video files and/or the like. The detection of the media content associated with the webpage is not limited to file detection, and streaming representations of the various media types may be detected. For example, “rtsp” links that direct to streams representing audio content and/or video content may be detected and/or may be identified as media content in the detection of the media content associated with the webpage.

At step 210, the detection of the media content associated with the webpage may use a subset of known media types and/or known file types relevant to the current context. For example, an embodiment of the present invention may be associated with a specific portable music player or may have a mode which identifies media which may be rendered by the portable media player. In such an embodiment, the detection of the media content associated with the webpage may be configured to detect only the audio content types which the portable music player is capable of playing, such as, for example, MP3 audio files and WMV audio files. Limiting detected media types during the detection of the media content associated with the webpage may be more efficient relative to detecting all known types and subsequently removing irrelevant media types during the filtering of the media content.

The relevant media types may be detected using known file extensions. For example, JPEG image files typically have a “.jpg” extension, MP3 audio files typically have a “.mp3” extension, and QuickTime files typically have a “.mov” extension. Alternatively, the relevant media types may be detected using known MIME type associations as defined by the Internet Assigned Numbers Authority (IANA). For example, JPEG image files may be associated with a “image/jpeg” description, MP3 audio files may be associated with an “audio/mpeg” description, and MP4 video files may be associated with a “video/mp4” description. Therefore, the detection of the media content associated with the webpage may analyze the description of the webpage for content, links and/or references which have the known media types, file types, file extensions and/or MIME types associated with the media content.

At step 210, during the detection of the media content associated with the webpage, protocol exchanges with a remote web server and/or media server may be observed, may be initiated and/or may be analyzed. The protocol exchanges may be observed, may be initiated and/or may be analyzed to recognize the media types, the file types, the file extensions and/or the MIME types. For example, the MIME type associated with media content may be returned in response to a HTTP GET message requesting the media content. Thus, header information in an HTTP GET protocol exchange may be analyzed to determine whether the MIME type of the media content sent in response corresponds to a known media type.

In an embodiment, a portion of an object of the webpage may be requested from the remote web server and/or media server using a link and/or a reference to the content object discovered using the description of the webpage. Analysis of the portion of the object may be used to determine whether to identify the object as a whole as media content. For example, most media content types have up-front identifiers, known to one having ordinary skill in the art as “Magic Numbers,” placed at and/or near the front of the media content file. The up-front identifiers may be sufficient to identify the object as a media content file. For example, a Flash video file may begin with an up-front identifier of an ASCII representation of “FLV.” As a further example, leading portions of an MP4 or 3GPP file may have an up-front identifier of an “ftyp” atom having recognizable brands represented in ASCII form as “3gp4,” “3gp5,” “isom,” “mp41” and/or other brands. The definition of the recognizable brands may be found in standard specifications from ISO/IEC, 3GPP and/or other standards organizations, and such brands are known to one having ordinary skill in the art. Thus, the detection of the media content associated with the webpage in step 210 may involve requesting a portion of an object, parsing and/or analyzing the portion of the object to determine whether up-front identifiers and/or other identifying information are present, and/or determining whether to flag the media content for the filtering of the media content.

At step 210, the detection of the media content associated with the webpage may use media publication and/or syndication standards, such as, for example, RSS, to detect media associated with a webpage in an embodiment of the present invention. For example, if the webpage has and/or references an RSS feed, the detection of the media content associated with the webpage may involve analysis of the RSS feed to detect media content in the RSS feed. The present invention may make use of one or more of the methods described above for detecting media content identified with a webpage; however, the present invention is not limited to these methods and may employ other methods for media detection known to one having ordinary skill in the art.

Referring again to FIG. 4, after the detection of the media content associated with the webpage at step 210, the filtering of the media content may remove the media content not relevant to the current context as generally shown at step 215. The filtering of the media content may use context information provided at step 214. The context information may indicate the current context and/or may determine context-specific behavior of a filter used in the filtering of the media content. The context information may be, for example, user input, user preferences, an application state, a current task, a list of one or more media destinations, media capabilities of the one or more media destinations, and/or the like.

The media capabilities may specify which media content types, file formats, codecs, bitrates, resolutions, aspect ratios, color depths, sampling rates and/or the like may be supported by and/or may be appropriate for the corresponding media destination. The media capabilities may specify which DRM technologies may be supported by the corresponding media destination. Properties of a media content object may be compared to the media capabilities of the media destination to determine whether the media content object may be sent to, rendered by and/or otherwise used by the media destination.

If the application 10 has the transcoding engine 90, then the capabilities of the transcoding engine 90 may be used in the comparison. For example, the transcoding engine 90 may be capable of transcoding and/or reformatting Ogg audio files to the MP3 audio format. Therefore, the application 10 may determine that the capabilities of the transcoding engine 90 may allow a media content object available from a media content site, such as, for example, an Ogg audio file, to be sent to, rendered by, and/or used by a media destination which supports only MP3 audio files. Other capabilities of the transcoding engine 90, such as, for example, image transcoding, video transcoding, reformatting of file formats and/or transport mechanisms, translation from one DRM technology to another, and/or the like, may be similarly used in the determination of whether a media content object may be suitable for use with a media destination.

One or more of the media destinations may be, for example, an available rendering device to which the media content may be sent. The rendering device may be, for example, a networked television, a networked stereo, a networked photo frame, a gaming console, a desktop PC with rendering capabilities, a laptop PC with rendering capabilities, and/or the like. The rendering device may support standard networking and/or communication protocols, such as, for example, UPnP AV and/or DLNA.

The media capabilities of the rendering device may be obtained using a capability discovery protocol exchange involving the rendering device. For example, for a UPnP AV compatible networked television, the DDC component 110 may use a standard UPnP discovery and description protocol exchange to obtain the media capabilities of the UPnP AV compatible networked television. In an embodiment, the DDC component 110 of the application 10 may execute the capability discovery protocol exchange. Alternatively, the media capabilities for the rendering device may be provided by a database, may be specified by the user 40 in a device configuration step, may be otherwise determined by the application 10, and/or may be determined using a combination of these techniques. For example, the capability discovery protocol exchange may identify a manufacturer and/or a model of a rendering device and/or may list media file formats compatible with the rendering device. Then, the manufacturer, the model and/or the compatible media file formats may be augmented by more detailed capability information which may not be provided by and/or may not be representable in the capability discovery protocol exchange. For example, the more detailed capability information may be retrieved from a database using the manufacturer and/or the model information obtained using the capability discovery protocol exchange.

One or more of the media destinations may be, for example, a portable media playback device to which the media content may be copied, may be synchronized and/or may be sent. The portable media playback device may be, for example, a portable music player, a portable video player, a portable gaming device, a PDA, a mobile telephone and/or the like. The media capabilities of the portable media playback device may be obtained using standard capability exchange methods associated with a connection protocol, such as, for example, MTP. Alternatively, the media capabilities of the portable media playback device may be provided by a database, may be specified by the user 40 in a configuration step, may be otherwise determined by an application 10, and/or may be determined using a combination of these techniques.

One or more of the media destinations may be, for example, a media library, a local media server and/or a media storage device to which the media content object may be downloaded, copied and/or stored. The media library may be associated with a media player and/or a media management application. The media capabilities of the media library may specify the media which is compatible with the associated media player and/or which is appropriate for use with the associated media management application. Alternatively, the media library may not be associated with a media player and/or a media management application and/or may not have restrictions on media compatibility. For such a media library, the media capabilities may indicate that any detected media files may be downloaded, may be copied and/or may be added to the media library.

The local media server and/or the media storage device may be associated with server software which may only support specific media content types and/or properties. The media capabilities of the local media server and/or the media storage device may be based on the media content types and/or properties supported by the server software. Alternatively, the local media server and/or the media storage device may enable storage of any media content with no restrictions. In this case, the media capabilities may indicate that any detected media files may be downloaded, copied and/or added to the local media server and/or the media storage device.

One or more of the media destinations may be, for example, a media organization structure such as a folder, a playlist and/or a bookmark area which may be created, accessed, managed and/or supported by the application 10. The media organization structure may be inherently associated with media capabilities. For example, the application 10 may provide a first bookmark area for audio content and a second bookmark area for video content. The bookmark area for audio content may be inherently associated with media capabilities indicating compatibility only with audio content. Alternatively, the media capabilities of the media organization structure may depend on a state of the media organization structure. For example, the application 10 may support a playlist structure which may be an audio playlist, a video playlist or a photo slideshow. The media capabilities of a newly created empty playlist structure may indicate compatibility with any media content. If the user 40 adds audio content to the playlist, the playlist may become an audio playlist. As a result, the media capabilities may change to indicate compatibility only with audio media content. Further, the application 10 may enable the user 40 to associate the playlist with a specific rendering device, such as, for example, a networked stereo supporting playback of only MP3 and AAC audio content. After association of the playlist with the networked stereo, the media capabilities associated with the playlist may change to reflect that the playlist may accommodate only MP3 and AAC audio content types.

These examples generally illustrate use of the media destinations and the associated media capabilities, and the present invention is not limited to these examples. The present invention is not limited to a specific embodiment of the media destinations or the associated media capabilities. The media destinations may be any destination capable of receiving the media content and/or a reference to the media, such as, for example, a link and/or a URL from which the media may be retrieved. For example, one or more of the media destinations may be a physical device, a physical storage location, a virtual storage location, an internal data structure represented in the memory of a computing device and/or the like.

The filtering of the media content at step 215 may generate the set of identified media content at step 230. The filtering of the media content at step 215 of FIG. 4 may involve multiple filtering stages and/or operations as generally illustrated in FIG. 5. The media content associated with the webpage which may be detected at step 210 of FIG. 4 may serve as input to the multiple filtering stages and/or operations in FIG. 5. As generally shown in FIG. 5, the filtering of the media content may use context-independent filtering and/or context-dependent filtering to enable identification of media content as appropriate.

At step 216, removal of unusable media content may apply the context-independent filtering described in more detail hereafter to remove and/or to filter the media content which may be unsuitable for use outside of the webpage. For example, minimum width and/or height threshold values may be applied to remove small image and/or video content, and minimum bit rate and/or sampling rate criteria may be applied to remove low quality audio and/or video content.

At step 217, removal of advertising content may apply the context-independent filtering described in more detail hereafter to remove and/or to filter the media content which may be advertising content. For example, the image and/or video content known to match standard sizes for advertising content may be removed, and image and/or video content may be filtered based on the aspect ratio of the image and/or video content. Further, the media content associated with known advertisement sources may be removed.

As a first example of the context-independent filtering of step 216 and/or step 217, the filtering of the media content may remove image content and/or video content which has a width, a height, a bitrate and/or a quality level below a threshold value. For example, images with a width less than fifty pixels and/or a height less than fifty pixels may be removed in the context-independent filtering because images of that size may be unusable in contexts outside the webpage. Such images may be, for example, framing elements, page graphics and/or icons in the webpage which may not be acceptable for uses outside the webpage.

As a second example of the context-independent filtering of step 216 and/or step 217, the filtering of the media content may remove audio content having a bitrate and/or a sampling rate below a threshold value. For example, MP3 audio files having a bitrate below 32 kbit/s may be removed in the context-independent filtering because the bitrate may be associated with a low quality level that may not be acceptable for use outside the webpage. For example, music files with a sampling rate less than twenty khz may be removed in the context-independent filtering because music reproduction at a sampling rate less than twenty khz may have a low quality level that may not be acceptable for use outside the webpage.

The context-independent filtering based on bitrate, audio sampling rate, and other measures of quality may be applied differently for different file types and/or codec types. For example, a bitrate-based quality threshold for H.264 visual content may be established as a lower value relative to a bitrate based quality threshold for MPEG-4 part 2 visual content. The bitrate-based quality threshold for H.264 visual content may be established as the lower value to reflect that H.264 is a more recent and more efficient video compression standard relative to MPEG-4 part 2 and, therefore, may achieve similar playback quality using a lower bitrate relative to an older and less efficient video compression standard such as MPEG-4 part 2.

As a third example of the context-independent filtering of step 216 and/or step 217, the filtering of the media content may remove image and/or video content having an aspect ratio above and/or below a threshold value. For example, in an embodiment, “width” may be defined as a width of the image content or the video content in pixels, “height” may be defined as a height of the image content or the video content in pixels, and “aspect ratio” may be defined as the width divided by the height. In this embodiment, if the aspect ratio of the image content and/or the video content exceeds a first threshold value, the image content and/or the video content may be removed in the context-independent filtering. Such content may be removed because visual content having a short and wide aspect ratio is typically either framing graphics for the webpage or advertising content in the form of a horizontal banner. Further, such content may be removed because visual content having a short and wide aspect ratio may be unusable outside the webpage.

If the aspect ratio of the image content and/or the video content is less than a second threshold value, the image content and/or the video content may be removed in the context-independent filtering. Such content may be removed because visual content having a tall and narrow aspect ratio is typically either framing graphics for the webpage or advertising content in the form of a vertical banner. Further, such content may be removed because visual content having a tall and narrow aspect ratio may be unusable outside the webpage. In an embodiment, the first threshold value may be three, and/or the second threshold value may be one third. The present invention is not limited to a specific embodiment of the first threshold value or the second threshold value, and the first threshold value and the second threshold value may be any values.

As a fourth example of the context-independent filtering of step 216 and/or step 217, the filtering of the media content may remove image and/or video content known to match standard sizes for advertising content. For example, image and/or video content having sizes specified by the “Ad Sizes Task Force” and/or sizes specified for compliance with the “Universal Ad Package” may be removed. Such sizes may have, for example, width×height dimensions of 728×90, 300×250, 160×600, 180×150 and/or other industry-standard sizes for advertisements known to one having ordinary skill in the art.

As a fifth example of the context-independent filtering of step 216 and/or step 217, the filtering of the media content may remove image and/or video content associated with known advertisement sources. The application 10 may access a list of internet sources, domain names, URL patterns and/or the like which are known to provide advertising content and/or which may be unlikely to provide media content usable outside the webpage. The Internet sources, the domain names, the URL patterns and/or the like may be accessed using a database which may be local or may be remote to the application 10. The database may be accessible using the internet and/or may be updated to reflect changes in the known advertisement sources. The known advertisement sources may be, for example, “adlegend.com,” “doubleclick.net,” “eyewonder.com,” “openx.org” and/or other sources known to provide advertisements.

The context-independent filtering described in these examples may remove the media content which may not be suitable for media management, organization, retrieval, consumption and/or rendering tasks which may be supported by the application 10. The context-independent filtering described in the above examples may remove the media content which may not be usable by the media destinations which may be supported by, may be known to and/or may be accessible to the application 10.

The filtering of the media content may involve context-dependent filtering which may use the context information as described in more detail hereafter. For example, the application 10 may enable the user 40 to establish user preferences that indicate media content which the user 40 desires to consume. Further, the user preferences may indicate media content which the user 40 does not find useful and/or which the user 40 does not desire to be identified. For example, the user 40 may only desire the application 10 to identify audio content which the user 40 considers to be of high quality. For example, the user 40 may establish a user preference to only identify audio content encoded losslessly, such as, for example, audio content encoded using audio compression techniques known to be lossless. Alternatively, the user 40 may establish a user preference to identify non-lossless audio content, but the user 40 may set high quality thresholds for the audio content. For example, the user 40 may indicate that stereo MP3 content must have a minimum bitrate of 192 kbit/s to be identified and/or that stereo AAC audio content must have a minimum bitrate of 128 kbit/s to be identified. The user 40 may indicate that audio content generally must have a minimum sampling rate of 44.1 khz to be identified.

Referring again to FIG. 5, the user preferences may be established at step 218. For example, the user preferences may be provided by and/or may be based on user input. At step 221, the user preferences may be applied to remove media content. The user preferences may be applied to allow or prevent the identification of media content according to the user preferences. For example, the user 40 may have established a user preference to identify only video content which is at least at VGA resolution, namely 640×480 pixels. In this case, application of the user preference may remove the video content having a width of less than 640 pixels or a height of less than 480 pixels. As another example, the user 40 may have established a user preference to identify Windows Media Audio content only if the Windows Media Audio content is encoded in stereo at a bitrate exceeding seventy-five kbit/s. In this case, application of the user preference may remove the Windows Media Audio content which does not meet these specifications.

At step 219, media capabilities of the available media destinations may be established. At step 222, the media capabilities may be used to remove media content based on the user input and/or the media capabilities of the available media destinations as described in more detail hereafter. The media destinations may be depicted and/or may be selectable in the user interface associated with the application 10. For example, user input provided to the application 10 at step 220 may select one or more of the media destinations. Then, the media capabilities of the selected one or more media destinations may be used to remove media content that does not match the media capabilities of the selected one or more media destinations.

The application 10 may enable the user 40 to establish user preferences regarding the media content types, the file types, the bitrates, the audio sampling rates, the image and/or video resolutions, the color depth and/or other properties of the media content which may reflect media content suitable for identification and/or may reflect media content unsuitable for identification. As a result, the context-dependent filtering may enable identification of media content matching the user preferences which describe suitable content, and/or the filtering of the media content may remove media content matching the user preferences which describe unsuitable content.

The application 10 may enable the user 40 to establish user preferences regarding the media destinations which may be accessible to the application 10. For example, the user 40 may have multiple rendering devices which may be capable of rendering music content. The user 40 may prefer one or more of the rendering devices. The user 40 may establish a user preference to direct the application 10 to only consider one or more preferred rendering devices of the available rendering devices for the redirection of music content. As a result, the context-dependent filtering may involve consideration of the media capabilities of the one or more preferred music rendering devices when redirecting the media content.

The application 10 may accept the user input using a user interface, such as, for example, the media workspace user interface 80 of the application 10. The user interface may present controls which may influence the filtering of the media content. As a first example of use of the user interface at step 221 and/or step 222, the user interface may enable the user 40 to display media content according to content types, such as, for example, image content, music content and/or video content. The user input may select a content type using the user interface. As a result, the media content of the selected content type may be identified. The media content of other content types may be removed during the context-dependent filtering. Thus, a user searching for music may provide user input indicating a current interest of music, and the filtering of the media content may be adjusted accordingly.

As a second example of use of the user interface at step 221 and/or step 222, the user interface may present a visual representation of the media destinations and/or may enable the user 40 to select a media destination of interest from the media destinations. For example, the user 40 may desire to select music content to redirect to a specific DLNA stereo rendering device. The user input in the user interface may select the specific DLNA stereo. As a result, the filtering of the media content may only enable identification of media content which matches the media capabilities of the specific DLNA stereo. Media content which is not compatible with the selected DLNA stereo may be removed by the context-dependent filtering. Selection of other media destinations may have similar effects. For example, the user input may select a media library associated with a music player, and/or the media library may only accommodate audio content. As a result, the filtering of the media content may involve identification of only the audio content appropriate for addition to the selected media library. Media content which is not appropriate for addition to the selected media library may be removed by the context-dependent filtering.

The user interface may present a control to turn off filtering. The user 40 may select the control to allow identification and/or use of media content which otherwise would be removed by the filtering of the media content. For example, the user 40 may desire to view advertisement content and/or low-quality content which the context-independent filtering may remove. The user input may select the control to turn off filtering. As a result, all of the media content may be identified.

The filtering of the media content may depend on a current task of the user 40 and/or a current state of the application 10. For example, the user 40 may organize media content in a “Favorite Videos” folder provided by the application 10. The context-dependent filtering may limit the identified media content to video content suitable for addition to and/or organization within the “Favorite Videos” folder. As another example, the user 40 may add media content to a photo album managed by the application 10. The context-dependent filtering may limit the identified media content to image content suitable for addition to the photo album.

The current state of the application 10 may indicate that the user 40 is selecting media for redirection to a rendering device in the home network. The current state of the application 10 may indicate that the user 40 has not selected a rendering device. The context-dependent filtering may depend on the media capabilities of the available rendering devices. The filtering of the media content may enable the identification of the media content which matches the media capabilities of at least one of the available rendering devices. The filtering of the media content may remove the media content which does not match the media capabilities of the available rendering devices.

More generally, the filtering of the media content may depend on the media capabilities of the available media destinations. In an embodiment, the filtering of the media content may only enable identification of the media content which matches the media capabilities of at least one of the available media destinations.

FIG. 5 generally illustrates an example of how the filtering of the media content may be implemented using multiple stages of filtering. One having ordinary skill in the art will recognize that variations in the organization, the grouping and/or the order of the steps of filtering may be made without departing from the scope of the current invention. In practice, such variations may be used to accommodate the specific media tasks and/or functionalities supported by the application 10. Further, such variations may be used to optimize computational efficiency of the filtering of the media content.

At step 230, the application 10 may generate the set of identified media content associated with the webpage. The identified media content may have and/or may be one media type or may have and/or may be a combination of various media types. For example, the identified media content may have one or more media types depending on the context information which may be used. The identified media content may correspond to media content which may be visible in, may be accessed from and/or may be rendered using the webpage.

Visual depictions of the media content as represented in the rendered webpage may vary in size and/or style. Further, the visual depictions of the media content as represented in the rendered webpage may be distributed throughout a spatially extensive webpage according to the organization and/or the formatting of the media content site that provides the webpage. Still further, the webpage is typically not editable in a web browser, which prevents selection, manipulation or arrangement of the visual depictions in the webpage. Thus, the visual depictions in the webpage may not enable the media management, organization, and/or redirection functions provided by the application 10.

The application 10 may create one or more symbolic representations for the identified media content. The symbolic representations may be displayed by the application 10. The symbolic representations may be selected, may be manipulated and/or may be used for the media management, organization, redirection and/or other enhanced media functions provided by the application 10 as described in more detail hereafter.

The symbolic representation of an identified media content object may have a text description, a graphic depiction or both. The text description may be, for example, a title, an artist, a song name, a TV show name, a file name and/or another displayable text description associated with the identified media content object. If a suitable text description may not be determined, the text description may be a generic description, such as, for example “music-1” or “video-7”.

The graphic depiction may be, for example, an image thumbnail, a video thumbnail, an album art thumbnail, a thumbnail depicting a music artist or a TV show logo, an icon representing the media content type, an icon representing the file format, an icon representing the audio and/or video codec, and/or the like. Thumbnails may be based on the visual depiction of the media content in the webpage, based on the media content, and/or based on a separate source of information. For example, the thumbnails may be based on information obtained from a database.

In a preferred embodiment, the symbolic representation of various identified media content objects may be a common size for all of the identified media content objects. For example, the symbolic representation of the various identified media content objects may be a graphic depiction with a common size of 32×32 pixels or 24×18 pixels. The common size may be any size, and the present invention is not limited to a specific embodiment of the common size. The application 10 may resize available images and/or available graphics to produce the symbolic representations having the common size. The common size may enable the symbolic representations to be presented, selected, manipulated and/or used in a common list, grid and/or workspace in a user interface presented by the application 10. For example, an identified music object may be represented textually by a song name and/or may be represented visually using a thumbnail created from a graphic album art image retrieved from a database using the song name. As another example, an identified image object may be represented textually by a text string “image-4” and/or may be represented visually using a thumbnail created from a graphic depiction of the image in the webpage. As yet another example, an identified video object may be represented textually by a file name associated with the video object, such as, for example, “jetsons-trailer.mp4”, and/or may be represented visually using an icon which may generically depict a MP4 video file format.

In an embodiment, the application 10 may analyze the description of the webpage to determine the text description and/or the graphic depiction for each media content object in the set of identified media content. If the text description and/or the graphic depiction cannot be found using analysis of the description of the webpage, the application 10 may observe, may initiate and/or may analyze protocol exchanges with a remote web server and/or media server. The application 10 may observe, may initiate and/or may analyze the protocol exchanges to determine the text description and/or the graphic depiction. If the text description and/or the graphic depiction cannot be found through observation, initiation, and/or analysis of the protocol exchanges, the application 10 may request a portion of the media content object from the remote web server and/or media server. The application 10 may examine the portion of the media content object to determine the text description and/or the graphic depiction. If the text description and/or the graphic depiction cannot be determined by these techniques, the application 10 may use a generic text description and/or a generic graphic depiction. For example, the generic text description and/or the generic graphic depiction may be based on a media type, a file format and/or a codec associated with the media content object.

In an embodiment, analysis of the webpage, the protocol exchanges and/or the portion of the media content object may be combined with corresponding analysis operations performed during detection of the media content associated with the webpage at step 210 of FIGS. 4 and 5. Such a combination of operations may wholly or partially determine the symbolic representation. The combination of operations may reduce a computational complexity and/or a delay required to produce the symbolic representation of the media content object.

In an embodiment, the application 10 may analyze the text description and/or the graphic depiction determined using the analysis of the description of the webpage, the protocol exchanges and/or the portion of the media content object. For example, the application 10 may analyze the text description and/or the graphic depiction to determine whether the text description and/or the graphic depiction may be a suitable description of the media content object. The application 10 may evaluate and/or may compare multiple candidate text descriptions and/or multiple graphic depictions of the media content object to determine a preferred text description and/or a preferred graphic depiction.

For example, the application 10 may compare multiple candidate text descriptions for a media content object. The multiple candidate text descriptions may have been found by analyzing multiple available sources, such as, for example, the webpage, the protocol exchanges, and/or the portion of the media content object. The multiple candidate text descriptions may be evaluated and/or may be examined by the application 10 based on the length of the text description, a presence or a lack of presence of whitespace characters in the text description, a probability distribution of alphanumeric characters in the text description, and/or the like. Based on such evaluation and/or examination, the application 10 may determine whether each candidate text description may be a human-readable description as opposed to a machine-readable unique identifier for the media content object. The application 10 may prefer a human-readable description relative to a machine-readable unique identifier.

For example, a human-readable description of an MP3 music object, such as, for example, “Ludacris—One More Drink,” may be preferred relative to a machine-readable identifier for the MP3 music object, such as, for example, “deeef65ac6a9d7e4dab30327dc5cbd8b.mp3.”

As another example, the application 10 may determine the graphic depiction of an MP3 music object by analyzing the webpage to create the graphic depiction. For example, the graphic depiction may be created from a visual depiction of a link to the MP3 music object as displayed in the webpage. The visual depiction of the link may be, for example, a 24×24 pixel GIF image. The application 10 may request a portion of the MP3 music object from a remote content server and/or may analyze the portion of the MP3 music object to determine an alternative graphic depiction. For example, the alternative graphic depiction may be created from a 200×200 pixel JPEG Album Art image which may be embedded in the MP3 music object and/or may be flagged as image type “$0x03” in an ID3v2 tag associated with the MP3 music object. The image type “$0x03” in the ID3v2 standard specifies that the image is a front album cover associated with the MP3 music object. Alternatively, the 200×200 pixel JPEG Album Art image may be retrieved from a database using metadata properties, such as, for example, “Artist Name,” “Song Name,” “Album Name” and/or the like. The metadata properties may be found using analysis of the portion Of the MP3 music object. In either case, the application 10 may prefer the graphic depiction created from the 200×200 pixel JPEG Album Art image relative to the graphic depiction created from the 24×24 pixel GIF image.

In an embodiment, the application 10 may use a first analysis operation of low complexity and/or low delay to determine the text description and/or the graphic depiction of the media content object. The application 10 may display and/or may utilize the symbolic representation of the object based on the text description and/or the graphic depiction in the user interface of the application 10. Then, the application 10 may determine a preferred text description and/or a preferred graphic depiction of the media content object using a second analysis operation which may have higher complexity and/or higher delay relative to the first analysis operation. Then, the application 10 may update the symbolic representation of the media content object in the user interface based on the preferred text description and/or the preferred graphic depiction. For example, the first analysis operation may be analysis of the webpage, and/or the second analysis operation may be analysis of a retrieved portion of the media content object.

In an embodiment, the application 10 may determine whether the symbolic representations for the identified media content should be based on a text description, a graphic depiction or both. For example, the application 10 may determine the graphic depictions for a first set of image content objects using the visual depictions of the first set of image content objects in the webpage. The application 10 may determine that the only text descriptions available for the first set of image content objects are machine-readable unique identifiers for the image content objects. As a result, the application 10 may create, may display and/or may use symbolic representations for the first set of image content objects based solely on the graphic depictions. As a second example, the application 10 may determine graphic depictions for a second set of image content objects using the visual depictions of the second set of image content objects in the webpage. The application 10 may also determine suitable human-readable text descriptions from filenames associated with the second set of image content objects. As a result, the application 10 may create, may display and/or may use symbolic representations for the second set of image content objects based on a combination of the text descriptions and the graphic depictions.

The application 10 may display one or more of the symbolic representations for the identified media content to enable enhanced multimedia functions, such as, for example, media management, organization, bookmarking, marking of favorites, rendering, downloading, redirection to rendering devices in the home network, synchronization to portable media players, use of playlists, and/or like functions using the identified media content. The symbolic representations may be displayed in a workspace area with control elements, visual representations of the available media destinations, symbolic representations of additional media content, and/or the like. For example, the workspace area may be displayed using the media workspace user interface 80 of the application 10.

The workspace area may be displayed concurrently with the webpage to provide the enhanced multimedia functions. Concurrent display of the enhanced multimedia functions and the webpage may integrate the enhanced multimedia functions with a web browsing experience. Accordingly, the user 40 may access, may view, may navigate and/or may interact with an original representation of the identified media content in the webpage while simultaneously accessing, viewing and/or using the symbolic representations of the identified media content displayed in the workspace area. For example, the user 40 may access, may view and/or may use the symbolic representations of the identified media content with the enhanced multimedia functions.

Therefore, in an embodiment of the present invention, the application 10 may provide the enhanced multimedia functions for use with any webpage having media content. The enhanced multimedia functions provided by the application 10 may have an appearance, a user interaction model and/or a set of enabled media functions which may be consistent for various webpages having media content which may be visited by the user 40. Further, the application 10 may provide the enhanced multimedia functions which may utilize the media content associated with a webpage without requiring a download of the media content to a local media library and/or local media server, without requiring exit from the web browsing experience, and/or without requiring a separate media management application to provide the enhanced multimedia functions. Therefore, the application 10 may enable the user 40 to utilize the enhanced multimedia functions provided by the application 10 while simultaneously retaining access to the organization, the presentation and/or the recommendation properties available in the webpage.

The workspace area provided by the application 10 may enable the user 40 to select, manipulate, organize and/or arrange the symbolic representations of the identified media content. The workspace area provided by the application 10 may enable the user 40 to redirect one or more of the identified media content objects to one or more of the media destinations. The workspace area provided by the application 10 may enable the user 40 to select one or more of the symbolic representations of the identified media content to determine compatibility of the associated one or more media content objects with one or more of the media destinations. The workspace area provided by the application 10 may enable the user 40 to select one or more of the media destinations to determine the identified media content objects which may be compatible with the selected one or more media destinations.

The workspace area may provide controls, functions, sub-areas and/or structures which may enable the user 40 to collect, to mark and/or to arrange the symbolic representations of the identified media content objects. For example, the workspace area may enable the user 40 to bookmark a selected media content object, to mark a selected media content object as a “favorite” media content object, to place a selected media content object in a folder which may be located in a hierarchy of folders, and/or to incorporate a selected media content object into a playlist.

Bookmarks, favorites, folders, playlists and/or other similar structures may persist in the workspace area as the user 40 visits multiple webpages using browser controls which may be provided by a web browser. As a result, the bookmarks, the favorites, the folders, the playlists and/or the other similar structures may enable the user 40 to collect, to arrange, to combine and/or to mix the media content from multiple webpages.

The workspace area may provide symbolic representations of locally stored media content which may be displayed with the symbolic representations of the identified media content associated with visited webpages. Accordingly, the bookmarks, the favorites, the folders, the playlists and/or the other similar structures may enable the user 40 to combine the identified media content associated with one or more of the webpages with the locally stored media content. The locally stored media content may be stored in an available media library, may be stored by an accessible media server in a home network, and/or may be other content available in a local network.

For example, the user 40 may use controls presented in the workspace area to create a music playlist, may visit multiple webpages having music content, and/or may use the symbolic representations of the identified media content which appear in the workspace area to add the corresponding music content objects to a music playlist. The user 40 may use the symbolic representations of the locally stored music content presented in the workspace area to add one or more locally stored music content objects to the playlist. Therefore, the user 40 may create the playlist containing a combination of the locally stored music content and the identified media content from the visited webpages. The controls presented in the workspace area may enable the user 40 to save the playlist, play and/or listen to music associated with the playlist using the device which hosts the application 10, and/or redirect the music associated with the playlist to a rendering device in the home network.

In an embodiment, in response to the user 40 navigating to a new webpage, the application 10 may populate the workspace area with the symbolic representations of the identified media content associated with the new webpage. The application 10 may maintain a media sub-area of the workspace area which may be populated with symbolic representations of some or all of the identified media content for a currently displayed webpage.

In an embodiment, the application 10 may populate the workspace area with the symbolic representations of the identified media content from multiple webpages which are displayed in a tabbed browsing and/or a multi-page browsing view in a web browser user interface. The application 10 may maintain the media sub-area of the workspace area which may be populated with the symbolic representations of some or all of the identified media content associated with the multiple webpages which the web browser may have opened in separate tabs and/or in the multiple webpages which may be available in the web browser user interface.

In an embodiment, the application 10 may not clear the symbolic representations of the identified media content objects from the workspace area in response to the user 40 opening and/or navigating to a new webpage. The application 10 may accumulate the symbolic representations of the identified media content objects which have been added to the workspace area by the user 40 in opening, visiting, navigating to and/or displaying multiple new webpages.

In an embodiment, the application 10 may enable the user 40 to transfer, to copy, and/or to move the identified media content objects from the currently displayed webpage into the workspace area. The application 10 may present controls in the webpage which may identify the identified media content objects in the webpage and/or may enable the user 40 to view, to access, to create and/or to use the symbolic representation of the identified media content in the workspace area. For example, the application 10 may display a handle in the webpage in association with each of the identified media content objects. The user 40 may drag the handle from the webpage to the workspace area to provide the symbolic representation of the corresponding identified media content object in the workspace area. As another example, the application 10 may present visible controls, such as, for example, buttons, right-click menu options and/or other similar controls, in the webpage. The visible controls may be associated with the identified media content objects such that the application 10 may respond to the user 40 invoking one or more of the controls by adding a corresponding symbolic representation of the identified media content object to the workspace area.

In an embodiment, the application 10 may highlight the visual representation of one or more of the identified media content objects in the webpage in response to selection of the symbolics representations of the one or more identified media content objects in the workspace area. The application 10 may highlight the symbolic representations of the one or more media content objects in the workspace area in response to user input identifying the corresponding one or more identified media content objects in the webpage. The user input may be, for example, selection of a control associated with the visual representation of the identified media content object in the webpage, a “mouseover” action on the visual representation of the identified media content object, creating and/or moving a selection box surrounding one or more of the visual representations of the identified media content objects, and/or the like. In an embodiment, the application 10 may highlight the symbolic representation of the identified media content object in the workspace area to indicate that the identified media content object is currently being played and/or rendered in the webpage.

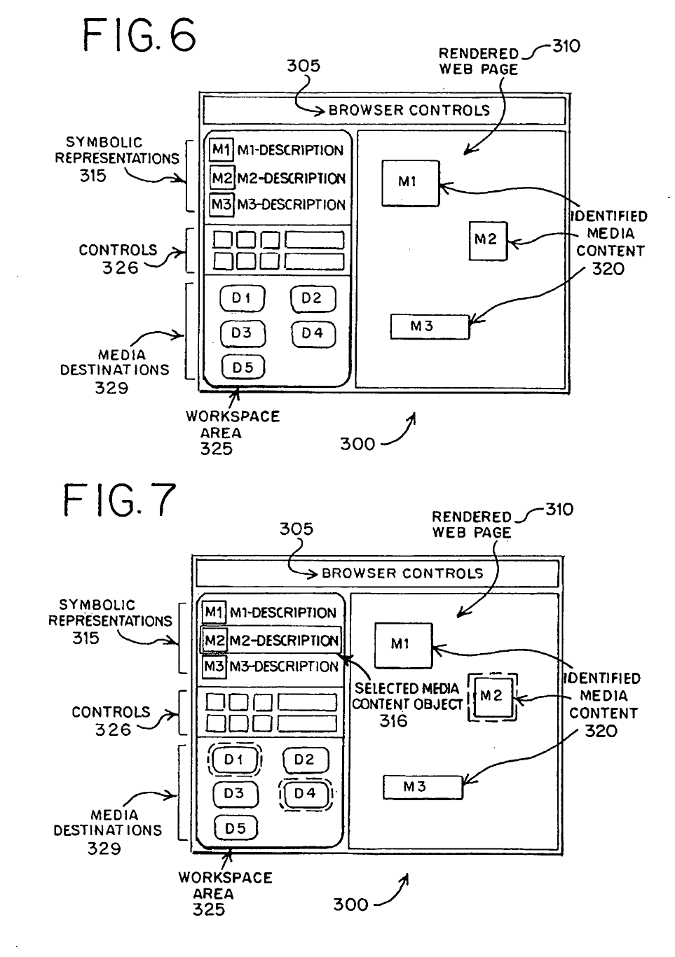

FIGS. 6-12 generally illustrate the user interface 300 of the application 10 in embodiments of the present invention. As generally shown in FIG. 6, the user interface 300 of the application 10 may provide web browser controls 305 and/or may render one or more webpages 310. The user interface 300 of the application 10 may present the symbolic representations 315 of the identified media content objects in the workspace area 325. As discussed previously, the application 10 may be an enhanced web browser application, may be a plug-in program for an existing web browser application, may be a separate application associated with and/or in communication with a web browser application. The present invention is not limited to a specific embodiment of the application 10.

The workspace area 325 may be an area of the user interface 300 which may be capable of displaying the symbolic representations 315 of the identified media content objects. The workspace area 325 may present controls 326 for selecting, manipulating, managing, organizing, examining, playing, downloading, sorting, displaying and/or filtering the identified media content objects using the symbolic representations 315 of the identified media content objects. The controls 326 may enable the user 40 to bookmark one or more of the identified media content objects, to mark one or more of the identified media content objects as a “favorite” media content object, to create, edit, manage and/or use playlists which may contain and/or may refer to one or more of the identified media content objects, and/or like media management functions. A selected media content object may be redirected to one or more of the media destinations. For example, one or more of the controls 326 may redirect the selected media content object to one or more of the media destinations. The media destinations may be represented, described, and/or graphically depicted by visual representations 329 of the media destinations in the workspace area 325.

In an embodiment, the controls 326 may have one or more source selection controls. The source selection controls may enable the user 40 to access the symbolic representations 315 of the identified media content objects from multiple sources. For example, the controls 326 may enable the user 40 to access the symbolic representations 315 of the identified media content objects from the one or more webpages 310 rendered by the user interface 300, from one or more previously visited webpages, and/or from one or more local content sources. Use of the source selection controls may result in the symbolic representations 315 of the identified media content objects from a selected source 341 appearing in a symbolic representations sub-area of the workspace area 325, in a separate area of the workspace area 325, and/or in another accessible location, such as, for example, a separate panel which may appear adjacent to the workspace area 325. Accordingly, the user 40 may utilize the symbolic representations 315 to select, manipulate and/or use media content objects from various media content sources.

In an embodiment, the controls 326 may have filtering controls. The filtering controls may provide, may alter and/or may influence the context information which may be utilized in the context-dependent filtering. As a first example, the filtering controls may have controls to limit display of the symbolic representations 315 to the symbolic representations associated with identified media content objects of a specific media type, such as, for example, image content, audio content and/or video content. As a second example, the filtering controls may have controls to establish and/or to change the user preferences established at step 218 of FIG. 5 which may be used to identify and/or filter the media content. As a third example, the filtering controls may have controls to filter the identified media content based on the media capabilities of one or more selected media destinations. As a fourth example, the filtering controls may have controls to turn off filtering. The present invention is not limited to a specific embodiment of the filtering controls, and the filtering controls may be any controls for use with the context-dependent filtering.

Referring again to FIG. 6, in an embodiment, the controls 326 may have media playback controls, such as, for example, Play, Pause, Stop, Fast Forward, Rewind, Skip to the next media object in a playlist or other list of media content objects, Skip to the previous media object in a playlist or other list of media content objects, and/or the like. The media playback controls may be applicable to controlling rendering of the media content objects on an available rendering device and/or the device which hosts the application 10.

The visual representations 329 of the media destinations may represent available rendering devices to which the identified media content objects may be sent; portable media playback devices to which the identified media content objects may be copied, synchronized and/or sent; media libraries, local media servers and/or media storage devices to which the identified media content objects may be downloaded, copied and/or stored; media organization structures, such as, for example, folders, playlists, and/or bookmark areas; and/or the like. The present invention is not limited to a specific embodiment of the media destinations, and the media destinations may be any destination capable of receiving the identified media content objects as known to one skilled in the art.

Many variations are possible for how the workspace area 325 may be presented and/or may be integrated with the user interface 300 and/or the browser controls 305 of the web browser. For example, the workspace area 325 may be a panel which may appear alongside, above and/or below the one or more webpages 310 rendered by the user interface 300. As a further example, the workspace area 325 may appear to “float” over the one or more webpages 310 rendered by the user interface 300. A position, a size and/or an appearance of the workspace area 325 may be adjustable and/or editable by the user 40. In an embodiment, the workspace area 325 may be persistent such that the workspace area 325 may be always present and/or may always be available. Alternatively, the workspace area 325 may be non-persistent such that the workspace area 325 may be revealed and/or may be hidden. For example, the workspace area 325 may be revealed and/or may be hidden based on user input, user interaction with controls integrated with the browser controls 305, user interaction with controls presented in the one or more webpages 310 rendered by the user interface 300, and/or user interaction with the visual representations 320 of the identified media content objects in the one or more webpages 310 rendered by the user interface 300. For example, the workspace area 325 may appear in response to the user 40 selecting and/or rendering one or more of the identified media content objects in the one or more webpages 310 rendered by the user interface 300. As another example, the workspace area 325 may appear if the one or more webpages 310 rendered by the user interface 300 has identified media content and/or may disappear if the one or more webpages 310 rendered by the user interface 300 does not have identified media content.

FIG. 6 generally illustrates display of the symbolic representations 315 for the identified media content in the workspace area 325 in an embodiment of the present invention. The user 40 may have navigated to a webpage of interest using the browser controls 305. The webpage of interest may be displayed as the one or more webpages 310 rendered by the user interface 300 as shown. The application 10 may identify and/or may filter the media content of the webpage as previously discussed to determine the set of identified media content. Then, the application 10 may create and/or determine the symbolic representations 315 of the identified media content objects as previously discussed. As shown in FIG. 6, the visual representations 320 of the identified media content objects may be “M1,” “M2,” and “M3” in the one or more webpages 310 rendered by the user interface 300. The application 10 may display the corresponding symbolic representations 315 of the identified media content objects in the workspace area 325. In the embodiment generally illustrated in FIG. 6, the symbolic representations 315 of the identified media content objects may have both text descriptions and graphic depictions. The graphic depictions may appear to the left of the text descriptions as shown in FIG. 6.

FIG. 6 generally illustrates that the workspace area 325 may appear to the left of the one or more webpages 310 rendered by the user interface 300. The controls 326, the symbolic representations 315 of the identified media content objects and/or the visual representations 329 of the media destinations may be displayed in the workspace area 325. The media destinations may be available rendering devices in a home network. For example, “D1” may represent a DLNA capable networked television set, and/or “D2” may represent a DLNA capable networked stereo. The application 10 may enable the user 40 to select one or more of the symbolic representations 315 to indicate a selected set of media content objects. The application 10 may allow the user 40 to move the selected one or more symbolic representations to the graphic depiction of “D1”. As a result, the application 10 may send, may redirect and/or may initiate rendering of the identified media content object associated with the one or more selected symbolic representations to the DLNA capable networked television.

FIG. 7 generally illustrates selecting one or more of the symbolic representations 315 using the workspace area 325 in an embodiment of the present invention. The layout of the user interface 300 may be similar to the layout of the user interface 300 previously described for FIG. 6. The user 40 may select one or more of the symbolic representations 315 available in the workspace area 325 to specify a selected set of one or more media content objects. In the specific example depicted in FIG. 7, the selected symbolic representation 316 represents selection of a single media content object M2. As a result, the selected symbolic representation 316 of the identified media content object M2 may be highlighted as shown in FIG. 7. The application 10 may identify, may mark and/or may highlight one or more of the visual representations 320 of the identified media content objects in the one or more webpages 310 rendered by the user interface 300. Thus, one of the visual representations 320 corresponding to “M2” may be highlighted as shown in FIG. 7. Highlighting of the one of the visual representations 320 corresponding to the selected media content object may enable the user 40 to determine which of the visual representations 320 of the identified media content objects correspond to the selected symbolic representation 316 in the workspace area 325. The selection of multiple symbolic representations 315 may result in identification, marking and/or highlighting of the corresponding multiple visual representations 320 of the identified media content objects.

In an embodiment, the application 10 may determine whether identified, marked, and/or highlighted visual representations of the visual representations 320 of the identified media content objects may be visible in a displayed portion of the one or more webpages 310 rendered by the user interface 300. The user interface 300 may automatically scroll the one or more webpages 310 rendered by the user interface 300 to ensure that one or more of the identified, marked and/or highlighted visual representations may be visible to the user 40.

The application 10 may identify, may mark and/or may highlight one or more of the visual representations 329 of the media destinations for which the media capabilities match the identified media content object of the selected symbolic representation 316. Thus, the visual representations of “D1” and “D4” may be highlighted as shown. Highlighting of the one or more of the visual representations 329 of the media destinations may enable the user 40 to determine which of the media destinations may be compatible with the one or more selected media content objects. In an embodiment, the user interface 300 may de-emphasize, reduce the size of, “gray out” and/or remove the visual representations 329 of the media destinations for which the corresponding media capabilities may not match the selected symbolic representation 316. The user interface 300 may rearrange the visual representations 329 of the media destinations such that the media destinations which may be compatible with the selected media content objects may be represented in a preferred position, such as, for example, at the top of a list of media destinations. Preferred, matching and/or compatible media destinations may be marked, highlighted and/or identified to the user 40 by any means known to one having ordinary skill in the art.

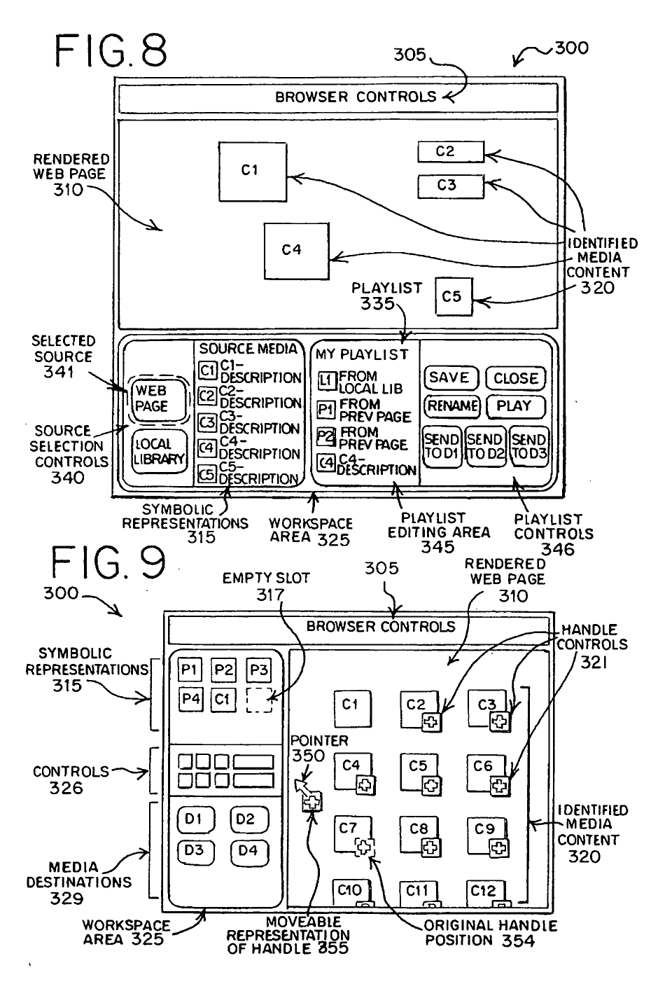

FIG. 8 generally illustrates creation and/or editing of a playlist 335 in an embodiment of the present invention. As shown, the workspace area 325 may appear below the one or more webpages 310 rendered by the user interface 300. The workspace area 325 may have source selection controls 340, the symbolic representations 315 of the identified media content objects, a playlist editing area 345 and/or playlist controls 346. As previously discussed, the source selection controls 340 may enable the user 40 to access the identified media content objects of the one or more webpages 310 rendered by the user interface 300. The source selection controls 340 may enable the user 40 to access the media content objects stored by one or more local content sources.

The user 40 may select one or more of the symbolic representations 315 to move a corresponding one or more of the identified media content objects to the playlist editing area 345 of the workspace area 325. The playlist editing area 345 may present the symbolic representations 315 for the identified media content objects associated with, contained in and/or referenced by the playlist 335. The user 40 may select, may move, may arrange and/or may organize the symbolic representations 315 in the playlist editing area 345 to create, to edit and/or to manage the playlist 335. The workspace area 325 may present the playlist controls 346 which may enable the user 40 to save, rename and/or render the playlist 335. Further, the playlist controls 346 may enable the user 40 to send and/or to redirect the playlist 335 to one or more of the media destinations. Still further, the playlist controls 346 may enable the user 40 to close the playlist editing area 345.

Selecting a “Play” control from the playlist controls 346 may enable the user 40 to render the playlist 335 and/or the media content objects associated with the playlist 335 using the device hosting the application 10. Selecting a “Send to D1” control from the playlist controls 346 may enable the user 40 to send and/or to redirect the playlist 335 and/or the media content objects associated with the playlist 335 to a Media Destination D1. For example, the Media Destination D1 may be a rendering device in the home network, such as, for example, a DLNA compatible networked stereo. Selecting a “Save” control from the playlist controls 346 may enable the user 40 to save the playlist 335 for future access and/or use. Selecting a “Rename” control from the playlist controls 346 may enable the user 40 to change a name and/or a filename of the playlist 335. The playlist controls 346 may have other controls for creating, managing, organizing and/or using the playlist 335 as known to one having ordinary skill in the art. The present invention is not limited to a specific embodiment of the playlist controls 346.

In FIG. 8, the user 40 may have selected a “Web Page” source selection control of the source selection controls 340. Accordingly, the symbolic representations 315 of the identified media content objects from the one or more webpages 310 rendered by the user interface 300 may be displayed in the symbolic representations sub-area of the workspace area 325. Alternatively, the user 40 may select a “Local Library” source selection control of the source selection controls 340 to access the media content objects stored by a local content library.

The playlist 335 may have a combination of media content objects from various sources. In FIG. 8, the media content object “L1” in the playlist 335 may represent a media content object from the local content library. The media content objects “P1” and “P2” in the playlist 335 may represent the identified media content objects from one or more previously visited webpages. The media content object “C4” may represent one of the identified media content objects from the one or more webpages 310 rendered by the user interface 300. As previously discussed, the playlist 335 and/or the playlist editing area 345 may persist as the user 40 successively visits multiple webpages and/or accesses the local content sources. The user 40 may edit, may modify, may expand and/or may save the playlist 335 during multiple browsing sessions. Thus, the playlist 335 may be created, may be edited and/or may be used so that the playlist 335 may have a combination of media content objects from multiple webpages and/or multiple local content sources.

FIG. 9 generally illustrates transfer, copying and/or moving of the media content objects from the one or more webpages 310 rendered by the user interface 300 to the workspace area 325 in an embodiment of the present invention. The presentation and/or the layout of the browser controls 305, the workspace area 325 and/or the one or more webpages 310 rendered by the user interface 300 may be similar to the presentation and/or the layout previously depicted. However, the specific embodiment of FIG. 9 may not assume that the application 10 automatically populates the symbolic representations 315 of the identified media content of the one or more webpages 310 rendered by the user interface 300 in response to the user 40 navigating to a new webpage. In this embodiment, the application 10 may enable the user 40 to specify which of the identified media content objects of the one or more webpages 310 rendered by the user interface 300 may be represented in the symbolic representation sub-area of the workspace area 325.

In FIG. 9, the visual representations 320 of the identified media content objects in the one or more webpages 310 rendered by the user interface 300 may be associated with handles 321. The handles 321 may identify the identified media content objects in the currently displayed webpage 110 which the user 40 may transfer, may copy and/or may move to the workspace area 325. For example, the user 40 may use a pointer 350, such as, for example, a mouse pointer, to indicate a selected handle of the handles 321. The user 40 may use the pointer 350 to move the selected handle to the workspace area 325. As a result, the symbolic representation 315 of the identified media content object associated with the selected handle may be created, may appear and/or may be accessible in the workspace area 325.

In FIG. 9, the selected handle may be associated with the identified media content object “C7” in the one or more webpages 310 rendered by the user interface 300. The pointer 350 may have been used to indicate the selected handle associated with the identified media content object “C7” in the one or more webpages 310 rendered by the user interface 300. The user 40, may use the pointer 350 to move a moveable representation 355 of the selected handle from an original handle position 354 to the workspace area 325. As a result, the symbolic representation 315 of the identified media content object “C7” may be created, may appear and/or may be accessible in the workspace area 325. The symbolic representation 315 may appear in an empty slot 317 of the symbolic representation sub-area of the workspace area 325.

The symbolic representations 315 of the identified media content objects may persist for multiple visited webpages. Thus, the symbolic representations “P1,” “P2,” “P3” and/or “P4” in FIG. 9 may represent the identified media content objects from the previously visited webpages. The symbolic representation “C1” in FIG. 9 may represent the identified media content object C1 visible in the one or more webpages 310 rendered by the user interface 300. In an embodiment, the application 10 may not display the handle 321 and/or allow movement of the handle 321 if the identified media content object already has one of the symbolic representations 315 in the workspace area 325, as shown for the symbolic representation “C1” in FIG. 9. In an embodiment, the application 10 may identify and/or may display the handle 321 only for the identified media content objects which may be relevant to the current task, the application state, the selected media destination, and/or another specific context.

FIG. 9 generally illustrates an example of the transfer, the copying and/or the moving of one or more of the identified media content objects from the one or more webpages 310 rendered by the user interface 300 to the workspace area 325. Other methods to transfer, to copy and/or to move one or more of the identified media content objects from the one or more webpages 310 rendered by the user interface 300 to the workspace area 325 will be apparent to one having ordinary skill in the art. For example, one or more the handles 321 may be replaced with a stationary control, such as, for example, a button or a right-click menu option. Selection of the stationary control associated with one of the identified media content objects may cause the corresponding one of the symbolic representations 315 to be created, to appear and/or to be accessible in the workspace area 325. In an alternative embodiment, the application 10 may enable a visual representation of the identified media content objects to be moved to the workspace area 325 using the pointer 350 and/or a similar mechanism. The visual representations 320 of the identified media content objects may be the visual representations 320 as typically displayed in the one or more webpages 310 rendered by the user interface 300, may be the graphic depictions of the media content objects determined as previously discussed, and/or may be other visual representations recognizable to the user 40.

The application 10 may enable the user 40 to simultaneously transfer, simultaneously copy and/or simultaneously move two or more of the identified media content objects from the one or more webpages 310 rendered by the user interface 300 to the workspace area 325. For example, the application 10 may enable the user 40 to create, to move and/or to trace a selection box in the one or more webpages 310 rendered by the user interface 300 to select two or more of the visual representations 320 of the identified media content objects. Then, the corresponding two or more of the identified media content objects may be simultaneously transferred, simultaneously copied and/or simultaneously moved into the workspace area 325. As another example, the application 10 may present an “Import All” control. The user 40 may select the “Import All” control to transfer, to copy and/or to move all of the identified media content objects from the one or more webpages 310 rendered by the user interface 300 to the workspace area 325.

In an embodiment, the application 10 may enable the user to transfer, to copy and/or to move one or more of the identified media content objects from the one or more webpages 310 rendered by the user interface 300 to one of the media destinations in the workspace area 325. As a result, the application 10 may redirect the one or more media content objects to the media destination. In an embodiment, the application 10 may enable the user to transfer, to copy and/or to move one or more of the identified media content objects from the one or more webpages 310 rendered by the user interface 300 to an organizational structure, such as, for example, the playlist 335 represented in the workspace area 325. As a result, the one or more media content objects may be incorporated into the playlist 335.

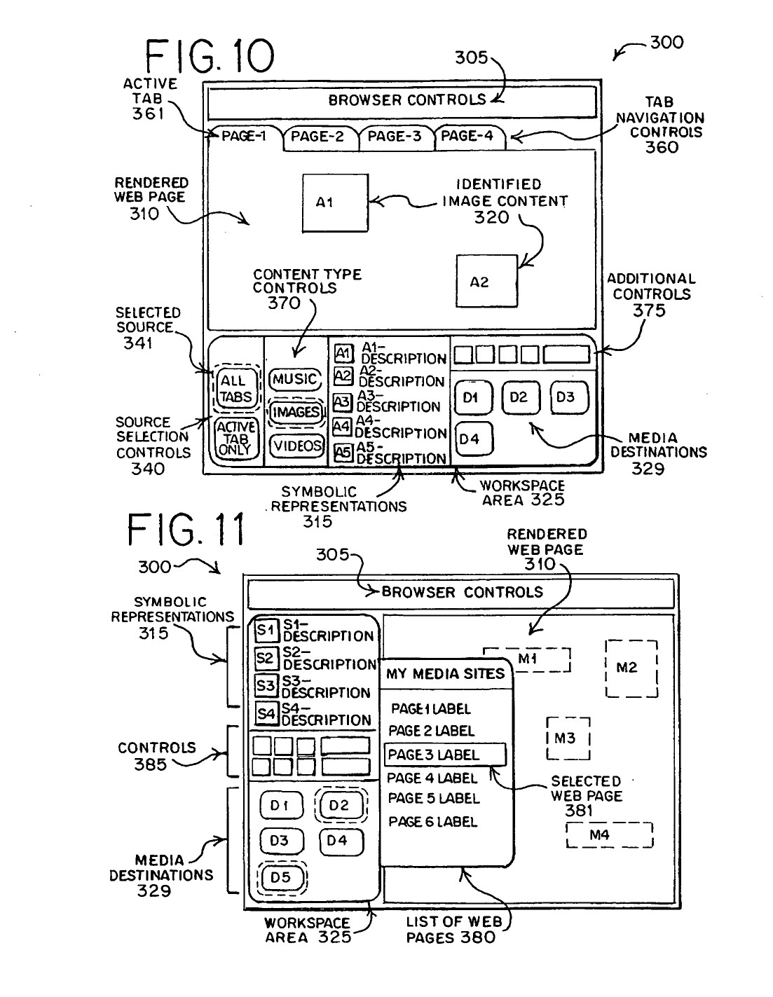

FIG. 10 generally illustrates the symbolic representations 315 for the identified media content objects of webpage tabs 360 in an embodiment of the present invention. The symbolic representations 315 for the identified media content objects of the webpage tabs 360 may be displayed in the workspace area 325. As known to one having ordinary skill in the art, the webpage tabs 360 may enable the webpages corresponding to the webpage tabs 360 to be open simultaneously in the user interface 300. Of the webpages, only the webpage for a single selected tab 361 (hereafter “the active tab 361”) of the webpage tabs 360 may be visible. The user 40 may view, may explore, may interact with and/or may use the webpage corresponding to the active tab 361. The user 40 may select another one of the webpage tabs 360 to access the webpage corresponding to the selected one of the webpage tabs 360. Then, the newly selected one of the webpage tabs 360 may become the active tab 361. Therefore, the user 40 may switch between the webpages without a need to reload the webpages and/or switch between different browser windows.

In FIG. 10, the user interface 300 may display the webpage tabs 360. The webpage 310 rendered by the user interface 300 may correspond to the active tab 361 labeled as “Page-1” in FIG. 10. The webpage tabs 360 may be displayed above the one or more webpages 310 rendered by the user interface 300. In FIG. 10, the identified media content objects “A1” and “A2” may be identified image content objects associated with the webpage 310 labeled as “Page-1.” Other identified image content objects labeled as “A3,” “A4” and “A5” may be associated with the webpages corresponding to the other webpage tabs 360 labeled as “Page-2,” “Page-3,” and “Page-4.” The other identified image content objects may not be visible because the webpages corresponding to the other webpage tabs 360 may be hidden by the user interface 300. The application 10 may determine the identified media content objects for each of the webpages corresponding to the webpage tabs 360. The application may determine the symbolic representations 315 for the identified media content objects for each of the webpages corresponding to the webpage tabs 360.

The application 10 may present the source selection controls 340 to specify which of the identified media content objects to display in the workspace area 325. For example, the user 40 may direct the application 10 to display all of the identified media content objects from the webpages in the workspace area 325 by selecting an “All Tabs” control of the source selection controls 340. As a further example, the user 40 may direct the application 10 to only display the identified media content objects from the webpage corresponding to the active tab 361 in the workspace area 325 by selecting an “Active Tab Only” control of the source selection controls 340. If the workspace area 325 only displays the identified media content objects from the webpage corresponding to the active tab 361, the user 40 may select one of the webpage tabs 360 to provide a new active tab 361. As a result, the user interface 300 may display the identified media content objects from the webpage associated with the new active tab 361 in the workspace area 325.

As shown in FIG. 10, the user 40 may have selected the “All Tabs” control of the source selection controls 340. Thus, the symbolic representations sub-area of the workspace area 325 may display the symbolic representations 315 for the identified media content objects aggregated from all of the webpages associated with the webpage tabs 360. Alternatively, if the user 40 selected the “Active Tab Only” control, the symbolic representations sub-area may only display the symbolic representations 315 for the identified media content objects associated with the webpage corresponding to the active tab 361. Using the specific example depicted in FIG. 10, if the user 40 selected the “Active Tab Only” control, the application 10 may only display the symbolic representations 315 for the identified media content objects “A1” and “A2.”

The application 10 may present content type controls 370 which may enable the user 40 to filter the symbolic representations 315 by content type. In the specific example of FIG. 10, the application 10 may present the content type controls 370 to enable the user 40 to indicate a selected content type, such as, for example, music content, image content and/or video content. In the specific example of FIG. 10, the user 40 may have used the content type controls 370 to indicate the selected content type of image content. Accordingly, the visual representations 320 of the identified media content in the webpages and/or the symbolic representations 315 in the workspace area 325 may correspond to image content. In an embodiment, the media content objects of other content types may not be identified and/or may not be represented in the workspace area 325 unless the user 40 changes the selected content type using the content type controls 370.

In an embodiment, the application 10 may determine a default content type and may initialize and/or may reset the content type controls 370 to reflect the default content type. For example, the application 10 may initialize and/or may reset the content type controls 370 to “Music Content” in response to the user 40 navigating to a webpage primarily associated with music content. As another example, the application 10 may initialize and/or may reset the content type controls 370 to “Video Content” to reflect that a webpage opened by the user 40 in a new one of the webpage tabs 360 is primarily associated with video content.

The application 10 may present additional controls 375 and/or the visual representations 329 of the media destinations for use with the symbolic representations 315 of the identified media content objects displayed in the workspace area 325. For example, the user 40 may select all of the symbolic representations 315 displayed in the workspace area 325. Then, the user 40 may move all of the symbolic representations 315 to a media destination which may, for example, represent a DLNA compliant networked television and/or a DLNA compliant photo frame which may be available in the home network. As a result, the application 10 may create a slideshow using the selected images and/or may initiate rendering of the slideshow on the television or the photo frame. The slideshow may be based on default presentation parameters which may be editable by the user 40. For example, the slideshow may utilize a five second display time for each of the selected images, may utilize a default transition technique such as “cross-fade,” and/or may arrange the selected images in a random presentation order.

Alternative embodiments of the present invention may use a list of webpages to access the media content associated with the webpages. The application 10 may retrieve a webpage from the list using a URL associated with the webpage, may identify media content associated with the webpage, and/or may create and/or may determine the symbolic representations 315 of the identified media content objects. The symbolic representations 315 may be displayed in the workspace area 325 to enable the enhanced multimedia functions which have been described previously. The alternative embodiments of the present invention may not display and/or render the webpage. The user 40 may access, may manage, may organize and/or may use the media content objects associated with one or more webpages without a need to display, examine, interact with and/or explore a corresponding representation of the one or more webpages 310.

The list of webpages may have a URL for each webpage in the list. In preferred embodiments, the list of webpages may associate a title and/or a description with each webpage in the list. The list of webpages may include additional properties and/or descriptive metadata about each webpage in the list. For example, the list of webpages may indicate one or more media content types with which the webpage may be associated.

The list of webpages may be, for example, a list of favorite media webpages flagged by the user 40 using controls provided by the application 10 in an embodiment of the present invention. The list of webpages may be, for example, provided by, generated from and/or imported from a “favorites” function and/or a “bookmarks” function of a web browser. The list of webpages may be, for example, compiled from media content sites previously visited by the user 40. For example, the list of webpages may be created based on the webpages previously visited by the user 40 having media, media of a specific type and/or media matching specific criteria. The list of webpages may be a list of media webpages stored by the application 10, provided to the user 40 by a provider of the application 10, and/or provided by a third party. The list of webpages is not limited to a specific embodiment, and the list of webpages may be any list of webpages produced by any means known to one having ordinary skill in the art.

The application 10 may create, may modify, may obtain, may access and/or may maintain the list of webpages. The application 10 may present the list of webpages to the user 40 and/or may enable the user 40 to select one or more of the webpages from the list to access the media content objects associated with the one or more selected webpages. The application 10 may have, may maintain, and/or may present multiple lists of webpages to enable the user 40 to select one or more of the webpages from the multiple lists of webpages. For example, the application 10 may maintain separate lists for “Favorite Music Sites,” “Favorite Image Sites” and “Favorite Video Sites.” In an embodiment, the application 10 may populate the workspace area 325 with the symbolic representations 315 of the identified media content objects in response to user selection of one or more webpages from the list and/or the multiple lists.

In an embodiment of the present invention, the application 10 may send, may redirect and/or may initiate rendering of the identified media content objects on a rendering device in response to user input redirecting one or more of the webpages from the list to the rendering device. The application 10 may copy, may synchronize and/or may send the identified media content objects to a portable media device in response to user input redirecting one or more of the webpages from the list to the portable media device. The application 10 may download, may copy and/or may add the identified media content objects to a local media library and/or a local media server in response to user input redirecting one or more of the webpages from the list to the local media library and/or the local media server. The application 10 may enable the user 40 to access, to view and/or to interact with the webpage corresponding to the webpage selected from the list.

FIG. 11 generally illustrates access of the identified media content objects associated with one or more of the webpages in a list of webpages 380 in an embodiment of the present invention. The user 40 may periodically visit specific media content sites and/or may have specific interests which may result in repeated use of one or more webpages available through the specific media content sites. For example, the user 40 may regularly visit a specific artist page available at a music content site. As another example, the user 40 may regularly visit a webpage which displays fan videos for a particular actor or actress. As yet another example, the user 40 may regularly visit a webpage which displays game highlight videos for a sport and/or a sports team which the user 40 follows. As yet another example, the user 40 may be an aviation fan and/or may enjoy viewing pictures of military jets which may be returned from a webpage which may be presented by an image search engine and/or which may be capable of being bookmarked.

The application 10 may present controls 385 to enable the user 40 to add the webpage 310 rendered by the user interface 300 to a list of webpages 380 which may be known to, may be accessed by and/or may be maintained by the application 10. The controls 385 may enable the user 40 to access the list of webpages 380 to select one or more webpages from the list 380. The controls 385 may enable the user 40 to access the identified media content objects of a selected webpage 381.

As shown in FIG. 11, the list of webpages 380 which may be entitled “My Media Sites” may be displayed adjacent to the workspace area 325. The user 40 may navigate the list of webpages 380 to indicate the selected webpage 381 from the list of webpages 380. In an embodiment, the application 10 may enable the user 40 to display the selected webpage 381 as one or more of the webpages 310 rendered by the user interface 300. The application 10 may enable the user 40 to access the identified media content objects associated with the selected webpage 381 without displaying the selected webpage 381 as the one or more webpages 310 rendered by the user interface 300. FIG. 11 generally illustrates that the one or more webpages 310 rendered by the user interface 300 may be a webpage visited previously using the browser controls 305. The one or more webpages 310 rendered by the user interface 300 may be unrelated to the webpages displayed and/or selected in the list of webpages 380.

As shown in FIG. 11, the user 40 may select the webpage “Page 3” from the list of webpages 380. As a result, the application 10 may retrieve the selected webpage 381 and/or may identify the media content objects associated with the selected webpage 381. The application 10 may create and/or may determine the symbolic representations 315 of the identified media content objects associated with the selected webpage 381. Then, the application 10 may populate the symbolic representations sub-area of the workspace area 325 with the symbolic representations 315 of the identified media content objects associated with the selected webpage 381.

In further response to selection of the selected webpage 381 from the list of webpages 380, the application 10 may highlight the media destinations for which, the media capabilities may correspond to the identified media content of the selected webpage 381. For example, as shown in FIG. 11, the application 10 may highlight the media destinations “D2” and “D5” to show that these media destinations may be capable of rendering the identified media content objects associated with the selected webpage 381. Highlighting of the media destinations may indicate to the user 40 that the selected webpage 381 may be redirected to the highlighted media destinations.

For example, the webpage “Page 3” may be a webpage associated with an image search engine which may have specific query parameters to execute a search for images of military fighter jets, such as, for example, “http://images.searchme.net/userquery?q=military+fighter+jets.” The identified media content objects associated with the webpage may be, for example, a set of digital photographs depicting military jets and other military aircraft. The highlighted media destinations “D2” and “D5” may represent a DLNA-compatible networked television and a DLNA-compatible photo frame, respectively, available in a home network. By moving and/or redirecting the webpage “Page 3” from the list of webpages 380 to the highlighted media destination “D5,” the user 40 may initiate a randomized slideshow of the digital photographs on the DLNA-compatible photo frame.

In an embodiment, the user 40 may select multiple webpages from the list of webpages 380 displayed by the user interface 100. For example, the user 40 may select both the webpage “Page 2” and the webpage “Page 6.” The webpage “Page 2” may have a combination of music content and music videos associated with a music artist, and the webpage “Page 6” may execute an image search using query parameters describing the name of the music artist. Thus, an aggregate set of identified media content objects compiled from the webpage “Page 2” and the webpage “Page 6” may have music content, video content and digital photographs related to the music artist. By selecting both the webpage “Page 2” and the webpage “Page 6,” the user 40 may access the symbolic representations 315 of the aggregate set of identified media content objects using the symbolic representations sub-area of the workspace area 325.

The user 40 may use the symbolic representations 315 of the identified media content objects with any of the previously described enhanced media functions and/or controls. For example, the user 40 may desire to view only music content objects. Filtering controls provided in the controls 385 of the workspace area 325 may be used to view only music content objects. After filtering to view only the music content, the user 40 may invoke a “Create Playlist” control provided by the workspace area 325 to create a music playlist and/or to add the music content objects. The music content objects may have originated in the webpage “Page 2.” However, the user 40 may not be required to access, view and/or interact with the webpage “Page 2” to access the associated identified media content objects and/or to create a playlist based on the associated identified media content objects.

Alternatively, the user 40 may select both the webpage “Page 2” and the webpage “Page 6” to view which of the media destinations may have media capabilities that correspond to the associated media content objects. In response, the application 10 may highlight the visual representations 329 of the media destinations which have media capabilities corresponding to the associated media content objects. For example, the application 10 may highlight the visual representations 329 of the media destinations to which the identified media content objects of the webpage “Page 2” and the webpage “Page 5” may be redirected. For example, the application 10 may highlight the visual representations 329 of any rendering devices in the home network which may be capable of rendering some or all of the identified media content objects associated with the webpage “Page 2” and/or the webpage “Page 6.”

A DLNA-compatible networked stereo device may be highlighted in the visual representations 329 of the media destinations displayed in the workspace area 325. The user 40 may move and/or may redirect both the webpage “Page 2” and the webpage “Page 6” to the one of the visual representations 329 corresponding to the networked stereo device. As a result, the application 10 may send, may redirect and/or may initiate rendering of music content objects associated with the webpage “Page 2” and/or “Page 6” to the networked stereo device. The application 10 may not send associated image content objects and/or associated video content objects because associated image content objects and/or associated video content objects may not match the media capabilities of the networked stereo device.

One of the visual representations 329 may correspond to a DLNA-compatible networked television and/or may be highlighted in the workspace area 325. The user 40 may move and/or may redirect both the webpage “Page 2” and the webpage “Page 6” to the one of the visual representations 329 corresponding to the networked television. As a result, the application 10 may send, may redirect and/or may initiate rendering of appropriate identified media content objects to the networked television. The application 10 may have a preference to send identified video content objects to television devices. For example, the application 10 may determine that the identified video content objects which originated from the webpage “Page 2” may be the only appropriate identified media content objects. Alternatively, the application 10 may not have a preference to send identified video content objects to television devices. The application 10 may have a capability to send photographic slide shows with background music to television devices. Thus, the application 10 may create a randomized slideshow based on the associated identified image content objects which originated from the webpage “Page 6,” may add background music based on random arrangement of the associated identified music content objects which originated from the webpage “Page 2,” and/or may send a resulting audiovisual slide show to the networked television device. The audiovisual slide show may be sent before, after, interleaved with and/or instead of the identified video content objects which originated from the webpage “Page 2.” For example, timing of transmittal of the audiovisual slide show relative to the identified video content objects which originated from the webpage “Page 2” may depend on user preferences.

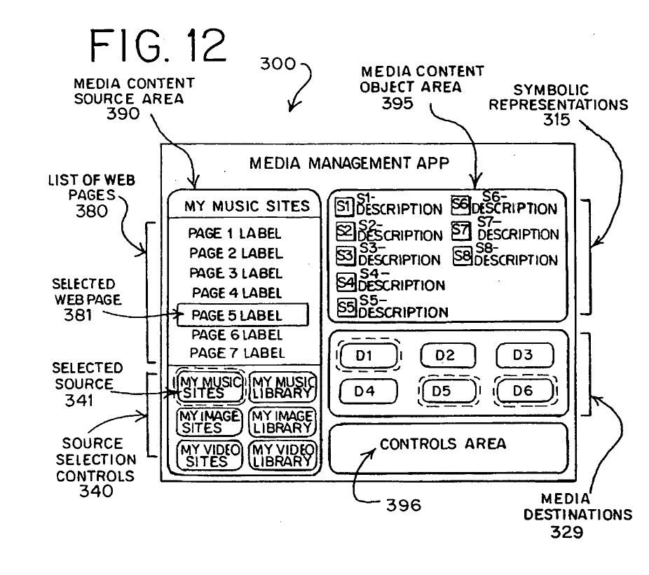

FIG. 12 generally illustrates the identified media content objects associated with one or more of the webpages in the list of webpages 380 in an embodiment of the present invention. The user interface 300 of FIG. 12 may be a user interface of a stand-alone media management application which may not have a web browser, may not present the browser controls 305 and/or may not have the capability to display the webpages. For example, the application 10 may be a media management application associated with a web browser and/or with a web browser plug-in program which may implement one of the previously described embodiments. Alternatively, the application 10 may be a stand-alone application capable of accessing a “Favorites” list, a “Bookmarks” list, a browsing history database and/or another suitable list of webpages which may be produced by a web browser, a plug-in program for a web browser and/or an application associated with a web browser. The application 10 may be any application which may access the list of webpages 380.

The application 10 may present the source selection controls 340 which may enable the user 40 to select one or more of the lists of webpages and/or to access one or more of the media libraries and/or the local content sources. If the user 40 uses the source selection controls 340 to indicate a selected list of webpages, the list of webpages 380 may be displayed in a media content source area 390 of the user interface 300. The user 40 may examine and/or may navigate the selected list of webpages to select one or more of the webpages in the selected list. Thus, the user 40 may access the identified media content objects associated with the one or more selected webpages.

As shown in FIG. 12, the user 40 may have selected a list of webpages entitled “My Music Sites.” Thus, a “My Music Sites” source selection control may be the selected source 341, and/or may be highlighted among the source selection controls 340. Further, a corresponding list of webpages may appear in the media content source area 390. The user 40 may have selected the webpage “Page 5” from the corresponding list of webpages. As a result, the application 10 may retrieve the selected webpage 381, may determine the identified media content associated with the selected webpage, may create and/or may determine the symbolic representations 315 of the identified media content of the selected webpage 381, and/or may populate a media content object area 395 of the user interface 300 with the symbolic representations 315 of the identified media content associated with the selected webpage 381.

Thus, the user 40 may access the symbolic representations 315 of the identified media content associated with the selected webpage 381 which may be a set of music content objects. The user 40 may access the media destinations displayed by the user interface 300. As in previously described embodiments, the application 10 may identify, may mark and/or may highlight the visual representations 329 of the media destinations for which the media capabilities may be compatible with the identified media content objects. As shown in FIG. 12, the media destinations “D1,” “D5” and/or “D6” may be highlighted.

The user 40 may move and/or may redirect one or more of the symbolic representations 315 of the identified media content objects to one or more of the media destinations. Alternatively, the user 40 may select one or more of the webpages from the list of webpages 380 to move and/or redirect the identified media content objects associated with the one or more webpages to one or more of the media destinations. For example, the user 40 may move and/or may redirect the webpage “Page 1,” the webpage “Page 2” and/or the webpage “Page 3” to the media destination represented by “D2” in FIG. 12. The media destination D2 may be, for example, a portable music player device. As a result, the aggregate set of identified music content objects associated with the webpage “Page 1,” the webpage “Page 2” and/or the webpage “Page 3” may be copied, may be synchronized and/or may be sent to the portable music player. As illustrated in the previous examples, various other enhanced media functions may be available based on the symbolic representations 315 of the identified media content objects, the media destinations and/or controls which may be presented in a controls area 396 of the user interface 300.

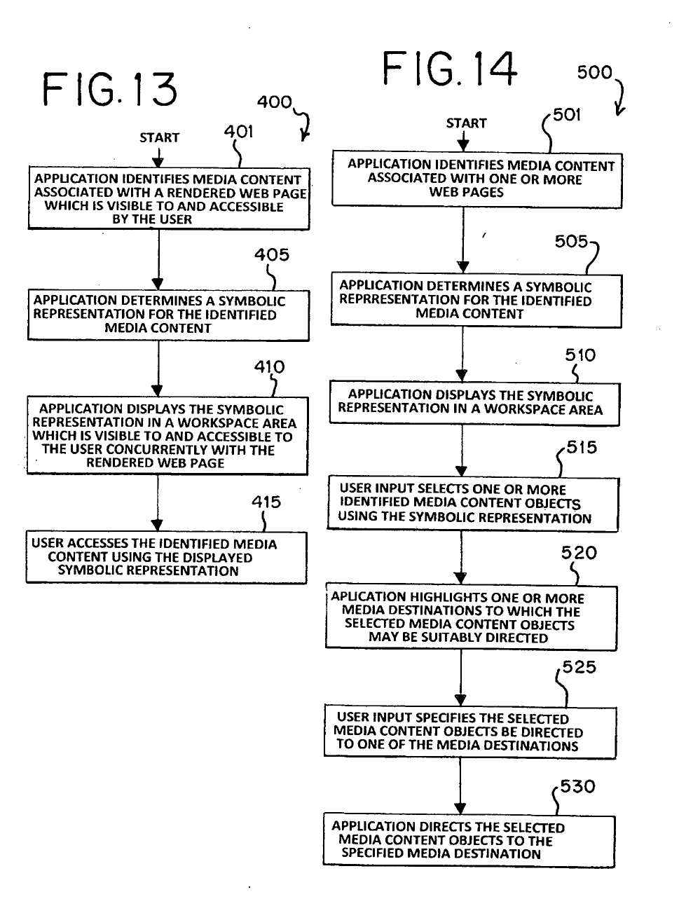

FIG. 13 generally illustrates a flowchart of a method 400 for managing internet media content in an embodiment of the present invention. As generally shown at step 401, the application 10 may identify the media content objects associated with a webpage. For example, as discussed previously, the application 10 may analyze and/or may process an available representation of the webpage to determine the identified media content objects associated with the webpage. The application 10 may detect the media content associated with the webpage and/or may implement the context-independent filtering and/or the context-dependent filtering to determine the identified media content objects associated with the webpage.

As generally shown at step 405, the application 10 may create and/or may determine a symbolic representation 315 for the identified media content objects. As generally shown at step 410, the application 10 may display the symbolic representation concurrently with the rendered webpage. For example, the application 10 may display the symbolic representation in the workspace area 325 of the user interface 300 that displays the rendered webpage. As generally shown at step 415, the user 40 may use the symbolic representation to access the identified media content objects. For example, the symbolic representation may be used for media management, organization, bookmarking, marking of favorites, playback, downloading, redirection to rendering devices in a home network, synchronization to portable media players, use of playlists, and/or like functions using the identified media content objects.

FIG. 14 generally illustrates a flowchart of a method 500 for managing internet media content in an embodiment of the present invention. As generally shown at step 501, the application 10 may identify the media content objects associated with one or more webpages. For example, as discussed previously, the application 10 may analyze and/or may process an available representation of the one or more webpages to determine the identified media content objects associated with the one or more webpages. The application 10 may detect the media content associated with the one or more webpages and/or may implement the context-independent filtering and/or the context-dependent filtering to determine the identified media content objects associated with the one or more webpages. In an embodiment, the one or more webpages may be rendered by the application 10. In an embodiment, the one or more webpages may not be rendered by the application 10.

As generally shown at step 505, the application 10 may create and/or may determine the symbolic representations 315 for the identified media content objects. As generally shown at step 510, the application 10 may display the symbolic representations in the workspace area 325 of the user interface 300. As generally shown at step 515, the user 40 may select one or more of the identified media content objects using the symbolic representations. As generally shown at step 520, the application 10 may highlight, may mark and/or may identify the media destinations which may be suitable for the selected media content objects. For example, the application 10 may use user preferences, user input and/or the media capabilities of the media destinations to determine which of the media destinations may be suitable for the selected media content objects. In an embodiment, the application 10 may not highlight, may not mark and/or may not identify the media destinations which may be suitable for the selected media content objects.

As generally shown at step 525, user input may specify that one or more of the identified media content objects be redirected to one or more of the media destinations. For example, the user input may specify that one or more of the identified media content objects be redirected to the media destinations which may be suitable for the selected media content objects. As generally shown at step 530, the application 10 may redirect the selected media content objects to the selected media destination. For example, the application may transmit the selected media content objects to the selected media destination using the home network.

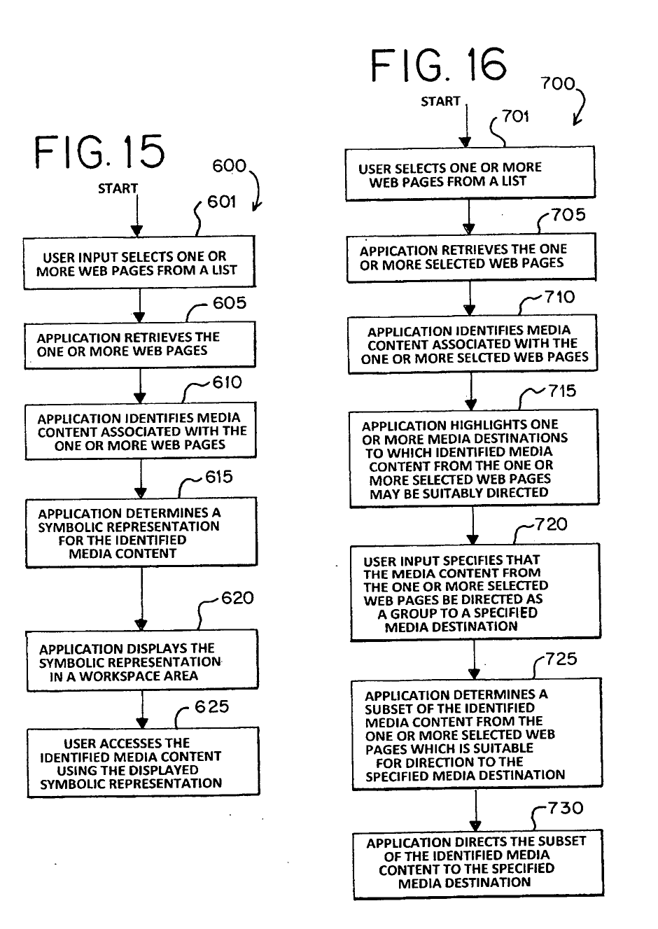

FIG. 15 generally illustrates a flowchart of a method 600 for managing internet media content in an embodiment of the present invention. As generally shown at step 601, user input may select one or more webpages from a list of webpages. As generally shown at step 605, the application 10 may retrieve the one or more selected webpages. As generally shown at step 610, the application 10 may identify the media content objects associated with the one or more selected webpages. For example, as discussed previously, the application 10 may analyze and/or may process an available representation of the one or more selected webpages to determine the identified media content objects associated with the one or more selected webpages. The application 10 may detect the media content associated with the one or more selected webpages and/or may implement the context-independent filtering and/or the context-dependent filtering to determine the identified media content objects associated with the one or more selected webpages. In an embodiment, the one or more selected webpages may be rendered by the application 10. In an embodiment, the one or more selected webpages may not be rendered by the application 10.

As generally shown at step 615, the application 10 may create and/or may determine the symbolic representations 315 for the identified media content objects. As generally shown at step 620, the application 10 may display the symbolic representations in the workspace area 325 of the user interface 300. As generally shown at step 625, the user 40 may use the symbolic representations to access the identified media content objects. For example, the symbolic representations may be used for media management, organization, bookmarking, marking of favorites, playback, downloading, redirection to rendering devices in a home network, synchronization to portable media players, use of playlists, and/or like functions using the identified media content objects.

FIG. 16 generally illustrates a flowchart of a method 700 for managing internet media content in an embodiment of the present invention. As generally shown at step 701, user input may select one or more webpages from a list of webpages. As generally shown at step 705, the application 10 may retrieve the one or more selected webpages. As generally shown at step 710, the application 10 may identify the media content objects associated with the one or more selected webpages. For example, as discussed previously, the application 10 may analyze and/or may process an available representation of the one or more selected webpages to determine the identified media content objects associated with the one or more selected webpages. The application 10 may detect the media content associated with the one or more selected webpages and/or may implement the context-independent filtering and/or the context-dependent filtering to determine the identified media content objects associated with the one or more selected webpages. In an embodiment, the one or more selected webpages may be rendered by the application 10. In an embodiment, the one or more selected webpages may not be rendered by the application 10.

As generally shown at step 715, the application 10 may highlight, may mark and/or may identify the media destinations which may be suitable for the identified media content objects. For example, the application 10 may use user preferences, user input and/or the media capabilities of the media destinations to determine which of the media destinations may be suitable for the identified media content objects. In an embodiment, the application 10 may not highlight, may not mark and/or may not identify the media destinations which may be suitable for the identified media content objects.

As generally shown at step 720, user input may specify that the identified media content objects of the selected webpages be redirected as a group to one of the media destinations. For example, the user input may specify that the identified media content objects of the selected webpages be redirected to a selected media destination. As generally shown at step 725, the application 10 may determine a subset of the identified media content objects which may be suitable for transmittal to and/or rendering by the selected media destination. For example, the application 10 may use user preferences, user input, properties of the identified media content objects and/or the media capabilities of the media destinations to determine the subset of the identified media content objects which may be suitable for transmittal to and/or rendering by the selected media destination.

As generally shown at step 730, the application 10 may redirect the subset of the identified media content objects to the specified media destination. For example, the application 10 may transmit the subset of the identified media content objects to the specified media destination.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. A method for managing Internet multimedia content in a network connected to the internet wherein a terminal is connected to the network, the method comprising the steps of:
displaying a first webpage on the terminal wherein the first webpage has objects;
identifying one or more of the objects as first media content objects wherein the first media content objects are automatically identified from the objects without user input identifying the first media content objects;
generating a first set of symbolic representations wherein each symbolic representation of the first set of symbolic representations depicts one of the first media content objects; and
concurrently displaying the first webpage and the first set of symbolic representations on the terminal wherein each of the symbolic representations of the first set of symbolic representations is displayed in a different location relative to the first media content object which the symbolic representation depicts.

2. The method of claim 1 further comprising the step of:
accepting user input on the terminal which identifies a type of content wherein the type of content is one of audio, video or images and further wherein the first set of symbolic representations depicts first media content objects which encode the type of content identified by the user input.

3. The method of claim 1 further comprising the step of:
using file type preferences to identify the first media content objects wherein the first media content objects have file types which correspond to the file type preferences.

4. The method of claim 1 further comprising the step of:
using properties of the objects to identify the first media content objects wherein the properties are at least one of width, height, aspect ratio, bitrate and quality level and further wherein the properties of the first media content objects meet a threshold value.

5. The method of claim 1 further comprising the step of:
analyzing protocol exchanges between the terminal and a remote server wherein the terminal analyzes the protocol exchanges to identify the first media content objects.

6. The method of claim 1 further comprising the step of:
obtaining a portion of one of the objects wherein the terminal uses the portion of the one of the objects to identify whether the one of the objects is one of the first media content objects.

7. The method of claim 1 further comprising the step of:
displaying a second webpage on the terminal after displaying the first webpage on the terminal wherein the second webpage and the first set of symbolic representations are displayed concurrently.

8. The method of claim 1 further comprising the step of:
displaying a second webpage on the terminal after displaying the first webpage on the terminal wherein second media content objects provided by the second webpage are automatically identified without user input identifying the second media content objects and further wherein a second set of symbolic representations is generated wherein each symbolic representation of the second set of symbolic representations depicts one of the second media content objects wherein the terminal concurrently displays the second webpage, the first set of symbolic representations and the second set of symbolic representations.

9. The method of claim 1 further comprising the step of:
processing a description of the first webpage wherein the terminal processes the description to identify the first media content objects.

10. The method of claim 1 further comprising the step of:
displaying a visual representation for each of a plurality of rendering devices connected to the network wherein the terminal concurrently displays the first webpage, the first set of symbolic representations and the visual representation for each of the plurality of rendering devices.

11. The method of claim 1 wherein each symbolic representation of the first set of symbolic representations is generated at least in part by analyzing at least one of a protocol exchange between the terminal and a remote server, a portion of one of the first media content objects, and a description of the first webpage.

12. The method of claim 1 further comprising the step of:
accepting first user input on the terminal which selects one or more of the first media content objects from the first webpage wherein the first set of symbolic representations includes symbolic representations which depict each of the one or more of the first media content objects selected by the first user input.

13. The method of claim 12 wherein the first user input selects the one or more of the first media content objects by visually moving the one or more of the first media content objects from the first webpage to a displayed area distinct from the first webpage.

14. The method of claim 12 further comprising the steps of:
displaying a second webpage on the terminal after displaying the first webpage on the terminal wherein the second webpage provides second media content objects;
accepting second user input on the terminal wherein the second user input identifies one or more of the second media content objects; and
concurrently displaying the second webpage, the first set of symbolic representations, and a second set of symbolic representations wherein each symbolic representation in the second set of symbolic representations depicts one of the second media content objects identified by the second user input.

15. The method of claim 1 further comprising the step of:
creating a playlist that has at least one of the first media content objects wherein the playlist is formed based on user input which selects one or more symbolic representations from the first set of symbolic representations.

16. The method of claim 1 further comprising the steps of:
accepting user input which identifies one or more of the first media content objects by selecting corresponding symbolic representations from the first set of symbolic representations; and
rendering the one or more of the first media content objects identified by the user input on a rendering device accessible to the terminal over the network.

17. The method of claim 1 wherein the first set of symbolic representations is displayed in a workspace area which is visually distinct from the first webpage.

18. The method of claim 1 further comprising the steps of:
displaying a visual representation of a portable media player on the terminal;
accepting user input on the terminal which identifies one or more of the first media content objects and identifies the portable media player;
retrieving the first media content objects identified by the user input wherein the terminal retrieves the first media content objects identified by the user input from at least one remote server after accepting the user input; and
transferring the first media content objects identified by the user input from the terminal to the portable media player.

19. A method for managing internet multimedia content in a network connected to the internet wherein a terminal is connected to the network, the method comprising the steps of:
displaying a list of webpages on the terminal;
accepting first user input on the terminal that identifies a first webpage from the list of webpages wherein media content objects are associated with the first webpage;
displaying symbolic representations for one or more of the media content objects associated with the first webpage without displaying the first webpage wherein the symbolic representations are displayed in response to the first user input; and
transmitting at least one of the media content objects associated with the first webpage to a media destination located outside of the terminal wherein the terminal transmits the at least one of the media content objects to the media destination without displaying the first webpage.

20. The method of claim 19 further comprising the steps of:
retrieving the first webpage from at least one remote server;
identifying the media content objects associated with the first webpage; and
generating the symbolic representations for the one or more of the media content objects associated with the first webpage wherein the terminal retrieves the first webpage, identifies the one or more of the media content objects, and generates the symbolic representations without displaying the first webpage.

21. The method of claim 19 further comprising the steps of:
accepting second user input on the terminal which selects one or more of the symbolic representations; and
transmitting one or more of the media content objects associated with the first webpage to the media destination wherein the media content objects transmitted to the media destination correspond to the one or more of the symbolic representations selected by the second user input.

22. The method of claim 19 further comprising the steps of:
displaying a visual representation for the media destination wherein the media destination has media rendering capabilities;
accepting second user input on the terminal which instructs the terminal to render the media content objects associated with the first webpage on the media destination wherein the second user input does not specify the media content objects to render;
identifying a first set of media content wherein the first set of media content consists of the media content objects associated with the first website which are appropriate for rendering on the media destination and further wherein the terminal identifies the first set of media content based on the rendering capabilities of the media destination; and
rendering the first set of media content on the media destination.

23. The method of claim 19 further comprising the steps of:
displaying a visual representation for each of a plurality of media destinations;
accepting second user input on the terminal which identifies the first webpage, a second webpage from the list of webpages, and the media destination from the plurality of media destinations;
identifying a first set of media content which consists of the media content objects associated with the first webpage wherein the terminal identifies the first set of media content;
identifying a second set of media content which consists of media content objects associated with the second webpage wherein the terminal identifies the second set of media content;
combining the first set of media content and the second set of media content into a common presentation wherein the common presentation is renderable using the media destination identified by the second user input; and
rendering the common presentation using the media destination identified by the second user input.

24. The method of claim 19 further comprising the steps of:
accepting second user input on the terminal which identifies one or more of the symbolic representations;
accepting third user input on the terminal which identifies one or more media files stored on a local media server; and
creating a playlist based on the second user input and the third user input wherein the playlist includes at least one of the media content objects associated with the first webpage and at least one of the one or more media files stored on the local media server.

25. The method of claim 19 wherein the media destination is a rendering device which renders the at least one of the media content objects transmitted to the rendering device.

26. The method of claim 19 wherein the media destination is a local content server which stores the at least one of the media content objects transmitted to the local content server.

27. The method of claim 19 wherein the media destination is a portable media player which stores the at least one of the media content objects transmitted to the portable media player.

28. A system for managing internet multimedia content, the system comprising:
a network connected to the internet;
a plurality of rendering devices connected to the network wherein each of the rendering devices has rendering capabilities; and
a terminal connected to the network wherein the terminal displays a first webpage which has objects and further wherein the terminal identifies media content objects from the objects without user input identifying the media content objects wherein the terminal uses the rendering capabilities to determine renderable media content objects from the media content objects and further wherein each of the renderable media content objects correspond to the rendering capabilities of at least one of the plurality of rendering devices wherein the terminal displays symbolic representations corresponding to the renderable media content objects.

29. The system of claim 28 wherein the terminal displays visual representations corresponding to the plurality of rendering devices wherein the terminal accepts user input which selects one of the visual representations and further wherein the terminal identifies to a user of the terminal which of the renderable media content objects are associated with the rendering capabilities of the one of the plurality of rendering devices which corresponds to the one of the visual representations selected by the user input.

30. The system of claim 28 wherein the terminal displays visual representations corresponding to the plurality of rendering devices wherein the terminal accepts user input which selects one of the symbolic representations and further wherein the terminal identifies to a user of the terminal which of the plurality of rendering devices is capable of rendering the one of the renderable media content objects which corresponds to the symbolic representation selected by the user input.

31. The system of claim 28 wherein the terminal acts as a UPnP AV Control Point.

32. The system of claim 28 further comprising:
a web browser on the terminal wherein the terminal uses the web browser to display the first webpage and further wherein the web browser supports a plug-in architecture; and
a browser plug-in module on the terminal wherein the browser plug-in module communicates with the web browser using the plug-in architecture of the web browser and further wherein the terminal uses the browser plug-in module to identify the media content objects, to determine the renderable media content objects, and to display the symbolic representations corresponding to the renderable media content objects.

33. A method for managing internet multimedia content in a network connected to the internet wherein a terminal is connected to the network, the method comprising the steps of:
retrieving a first webpage wherein the terminal retrieves the first webpage from at least one remote server;
displaying the first webpage in a first area of a display screen associated with the terminal;
displaying a first set of symbolic representations in a second area of the display screen wherein the symbolic representations depict media content objects and further wherein one or more of the symbolic representations depict the media content objects associated with the first webpage wherein the first webpage and the symbolic representations are displayed concurrently; and
rendering a first set of the media content objects selected by a user wherein the user selects the first set of the media content objects by selecting one or more of the symbolic representations.

34. The method of claim 33 wherein the first area and the second area are separate areas of the display screen.

35. The method of claim 33 wherein the second area is displayed as overlapping and at least partially obscuring a portion of the first area.

36. The method of claim 33 further comprising the step of:
displaying a visual representation for at least one rendering device wherein the visual representation of the at least one rendering device is displayed concurrently with the symbolic representations.

37. The method of claim 33 further comprising the steps of:
displaying a visual representation for each of a plurality of rendering devices wherein at least one of the plurality of rendering devices is remote with respect to the terminal; and
accepting user input on the terminal wherein the user input identifies a selected rendering device of the plurality of rendering devices and further wherein the first set of the media content objects is rendered on the selected rendering device.

38. The method of claim 33 further comprising the step of:
displaying page selection controls which indicate that multiple webpages are available in a current web browsing session wherein the page selection controls enable the user to select any of the multiple webpages for display and further wherein one or more of the symbolic representations depict media content objects associated with a second webpage which is one of the multiple webpages wherein the second webpage is a different webpage than the first webpage.

39. The method of claim 33 wherein one or more of the symbolic representations depict media files stored on a local content source available in the network and further wherein the first set of the media content objects includes at least one of the media content objects associated with the first webpage and at least one of the media files stored on the local content source.

40. The method of claim 33 further comprising the steps of:
obtaining rendering capabilities of a rendering device wherein the terminal obtains the rendering capabilities and further wherein the rendering device is accessible to the terminal over the network; and
processing the first set of the media content objects wherein processing modifies at least one of the media content objects of the first set of the media content objects to match the rendering capabilities of the rendering device.

41. The method of claim 33 further comprising the steps of:
obtaining rendering capabilities of each of a plurality of rendering devices accessible to the terminal over the network wherein the terminal obtains the rendering capabilities;
determining one or more rendering devices of the plurality of rendering devices which are capable of rendering the first set of the media content objects wherein the terminal uses the rendering capabilities to determine the one or more rendering devices which are capable of rendering the first set of the media content objects; and
visually indicating to the user the one or more rendering devices which are capable of rendering the first set of media content objects.

42. The method of claim 33 further comprising the step of:
creating a playlist based on user input on the terminal which identifies one or more of the symbolic representations wherein the playlist includes at least one of the media content objects associated with the first webpage.

43. The method of claim 33 further comprising the step of:
visually identifying one or more of the media content objects in the first webpage in response to the user selecting one or more of the symbolic representations wherein the one or more of the media content objects which are visually identified correspond to the one or more of the symbolic representations selected by the user.

44. The method of claim 33 further comprising the step of:
visually identifying one or more of the symbolic representations in response to the user selecting one or more of the media content objects in the first webpage wherein the one or more of the symbolic representations which are visually identified correspond to the one or more of the media content objects selected by the user.

45. The method of claim 33 further comprising the step of:
determining a default media type for the first webpage wherein the default media type is one of audio content, video content and image content and further wherein each of the media content objects depicted by the symbolic representations has the default media type.
